(19) United States
(12) Patent Application Publication
(10) Pub. No.: US 2026/0308484 A1
(43) Pub. Date: Oct. 8, 2026

(54) BIODEGRADABLE POLYOL PROPOXYLATES, THEIR PREPARATION, USES, AND COMPOSITIONS COMPRISING THEM

(71) Applicant: BASF SE, Ludwigshafen am Rhein (DE)

(72) Inventors: Sophia EBERT, Ludwigshafen am Rhein (DE); Joerg NIEBERLE, Ludwigshafen am Rhein (DE); Katarzyna GORCZYNSKA COSTELLO, Cincinnati, OH (US); Ruth CHILTON, Cincinnati, OH (US); Gang SI, Cincinnati, OH (US); Mu WANG, Cincinnati, OH (US); Frank HUELSKOETTER, Cincinnati, OH (US)

(21) Appl. No.: 19/481,207

(22) PCT Filed: Apr. 24, 2024
(86) PCT No.: PCT/EP2024/061284

§ 371 Date: Nov. 4, 2025

(30) Foreign Application Priority Data
May 5, 2023 (EP) 23171901.4

(51) Int. Cl. C11D 3/37; C08G 65/26; C11D 3/20; C11D 3/386

(52) U.S. Cl. CPC C11D 3/3703; C08G 65/2609; C11D 3/2068; C11D 3/386; C11D 2111/12

(57) ABSTRACT

This invention deals with biodegradable polyol propoxylates based on polyols possessing four to five —OH groups, their manufacture and uses, for example in laundry or dishwashing.

This invention deals with biodegradable polyol propoxylates (in this present invention abbreviated as “inventive compound”, or “inventive polymer”, or “compound of the invention” whenever the inventive polyol propoxylates are meant), their manufacture, their uses, particularly for use in cleaning compositions such as laundry detergent compositions, and specifically for improved clay removal and/or oily/fatty soil removal and/or body soil removal and/or whiteness maintenance in laundry care.

Detergent formulators are continuously faced with the task of developing improved products to remove a broad spectrum of soils and stains from fabrics and hard surfaces. Chemically and physico-chemically, the varieties of soils and stains spectrum range from polar soils, such as proteinaceous, clay, and inorganic soils, to non-polar soils, such as soot, carbon-black, by-products of incomplete hydrocarbon combustion, and organic soils like sebum and body soils. The removal of greasy (i.e., oily/fatty) stains has been a particularly challenging problem. This challenge has been accentuated by the recent high interest and motivation to reduce the level of surfactants in cleaning detergents for environmental, sustainability and cost reasons. A reduction of the amount of surfactants added, especially a reduction of anionic surfactants, such as linear alkyl benzene sulfonate, LAS, has typically been found to lead to an erosion of oily/fatty stain removal. Additionally, the global trend of using washing conditions at lower temperature further diminishes grease cleaning capabilities of typical detergents, since the class of oily and fatty stains shows the greatest performance drop when the temperature is decreased. On the other hand, clay soil stains, although in some instances contacting the fabric fibers with less force, nevertheless provide a specific type of soil removal problem due to the high degree of charge associated with the clay itself. This high surface charge density may act to repel some laundry ingredients, thus surfactants alone cannot remove or carry away the clay into the laundry liquor.

Another global trend is the compaction of laundry detergents, in order to improve the sustainability in terms of water usage and/or transportation costs, as well as to improve the convenience for the end consumer (e.g., single mono dose products, tabs, pouches and the like), which leads to a high market demand for new raw materials that have a higher weight-efficiency and a significantly broader performance profile.

A further strongly emerging trend is the desire to improve the “footprint” of any product, be it in terms of its origin like being from natural or renewable resources, or compared to previous products, its production in terms of production efficiency and thus reduced usage of energy, its efficiency in usage such as reduced amounts for the same performance or higher performance at the same amount levels used, its persistence in the natural environment after its usage, especially its biodegradation, since recycling is technically very challenging and therewith economically not attractive.

Hence, due to the climate change, one of the most important targets of the detergent and cleaner (D&C) industry today is to significantly lower the CO₂ emission per wash, by improving cold water conditions, improving the cleaning efficiency at low temperatures of 30 °C and below, and to lower the amounts of chemicals employed per wash, and increasing the weight-efficiency of the cleaning technologies. Another important target of the D&C industry is the need for biodegradable polymers, to improve the sustainability of the detergent formulations and to avoid the potential accumulation of the polymers or their degradation products, resulting from incomplete biodegradation of the polymers in the ecosystem, thus lowering the persistence in nature after usage of the materials.

As a result of these trends, there is a strong need for new biodegradable cleaning polymers that provide both excellent primary (i.e., soil removal) and secondary (i.e., whiteness maintenance) cleaning benefits for both hydrophobic and hydrophilic stains, and an improved biodegradability. The materials should exhibit good soil removal for oily/fatty/sebum and particulate stains and should also lead to improved whiteness maintenance, minimizing the amount of suspended and emulsified oily/fatty/sebum and particulate soil from redepositing on the surfaces of the textiles or hard surfaces. Preferably, the new ingredients would also display a synergy with other cleaning technologies, such as other cleaning polymers, surfactants and/or enzymes, known for improving solely the oily/fatty/sebum or particulate stain removal and/or whiteness of fabrics and hard surfaces, leading to further improved detergent compositions.

For example, alkoxylated polyalkylene imine and alkoxylated polyamine polymers, especially the class of alkoxylated hyperbranched polyethylene imine (PEI) and alkoxylated linear polypropylene imine (PPI) homo- and copolymers, are known in the literature to be able to contribute to particulate or to oily/fatty soil removal, especially at low surfactant levels and at cold water conditions (30 °C and below). Moreover, their biodegradation performance generally is poor, and thus not acceptable for current and future requirements. Ideally, the polymers are readily biodegradable, i.e., show equal to or more than 60% oxygen consumption after 28 days in the OECD 301F test or are they are considered moderately biodegradable then they show equal to or more than 40% after 28 days in the OECD 301F test. Alternatively, the polymers are inherently biodegradable in the OECD 302 B test, i.e., show equal to or more than 70% dissolved organic carbon (DOC) levels. Hence, there is a need to find improved polymer architectures with a similar or superior performance profile, a feasible preparation process and an improved biodegradation behavior.

In the following, a summary of the most relevant publications in the field of the present invention, polyol propoxylates, is given.

JP2022056680 A discloses glycerin modified with ethylene oxide and propylene oxide possessing in total 16 alkylene oxide units. The compound is disclosed in the context of a fragrance retaining agent.

Further, a propoxylated sorbitol (CAS 52625-13-5) is commercially available from several companies, including the PCC Group (Dolny, Poland; https://www.products.pcc.eu/de/cas-numbers-2/52625-13-5/). These propoxylated sorbitol compounds are commonly used for the production of rigid polyurethane foam (PUR) and semi-rigid polyurethane foam, for example in reaction with isocyanate.

In addition, several modified alkoxylated polyol compounds are known in the art. In this context, EP3802749 A discloses propoxylated or butoxylated polyols, i.e., glycerol, trimethylol propane, neopentyl glycol, and sorbitol further containing at least one fatty acid of 14 carbon atoms or more. These compounds are used as a synthetic ester lubricating base oil. U.S. Pat. No. 7,468,348 B discloses alkoxylated polyol, i.e., propoxylated sorbitol terminally modified with sulfate groups, aldehyde groups or a three-membered ring structure. U.S. Pat. No. 7,439,219 B discloses cleaning compositions comprising a surfactant and ethoxy, propoxy or butoxy modified polyols having at least three hydroxy moieties, wherein at least one of the hydroxy moieties or at least one of the alkoxy moieties is substituted by a quaternary amine capping unit.

EP3298120 A discloses detergent composition comprising propoxylated glycerin with a total of 1-10 propylene oxide units.

Surprisingly, the present inventors found that propoxylated polyols possessing 4 to 5 —OH groups and having propylene oxide (PO) branches that are shorter than 30 PO units demonstrate excellent wash performance and show a significant biodegradation. Based on experimentally generated data, it was possible to establish mathematical equations that allow the prediction of biodegradation based on (i) PO chain length, (ii) average number of —OH groups of the polyol and (iii) average number of ether linkages in the polyol. It is noted that the compounds of the invention have superior wash properties compared to the above-mentioned propoxylated glycerin compounds possessing an identical amount of propylene oxide units in the PO branches. Further, as described above, the inventive compounds demonstrate significant biodegradation (at least around 40% according to OECD 301F within 28 days) whereas propoxylated sorbitol, as known in the art, only shows biodegradability of less than 10% according to OECD 301F within 28 days. Further, the inventive compound also show good stability in cleaning composition, especially liquid cleaning composition. This high stability of the inventive compounds in liquid cleaning compositions may be based on the lack of ester and/or amide bonds

Therefore, the object of the present invention is to provide novel propoxylated polyols comprising a polyol core consisting essentially of four to five —OH groups, wherein at least one of the —OH groups is modified to form a polypropylene oxide branch and wherein the propoxylated polyol comprises polypropylene oxide branches comprising on average at least four polypropylene oxide units.

In the following, any alkylene oxide is generically referred to as “AO”, ethylene oxide is sometimes referred to as “EO”, propylene oxide as “PO”; butylene oxide as “BuO”. “PEO” is used sometimes herein to describe polyethylene oxide homopolymers or PEO-blocks within a larger polymer structure; likewise, “PPO” describes the polypropylene oxide homopolymers or polymer-blocks within a larger polymer structure.

A process to produce the inventive compounds is also part of this invention.

The use of the compounds of this invention for all kinds of applications for which the previously described polyamines, polyethylene imines, polypropylene imines, and their alkoxylated derivates have been used is encompassed by this present invention as well.

Compositions comprising such propoxylated polyols of this invention similar to those compositions in which the previously known polyamines, polyethylene imines, polypropylene imines, and their alkoxylated derivates have been employed—either the inventive propoxylated polyols instead of such known compounds or in combinations with such known compounds—forms part of this invention as well.

The term “compound of the invention”, or “inventive compound”, or “inventive polymer”, as used herein, refers to propoxylated polyols/polyol propoxylates (which may be used interchangeably herein) prepared as described below and/or in the appended claims.

Thus, subjects of the present invention are the following Embodiments 1 to 29 as defined and further explained with further embodiments hereinafter and further exemplified in the experimental section:

### Embodiment 1

A propoxylated polyol comprising a polyol core comprising, consisting of or consisting essentially of four to five —OH groups, wherein at least one of the —OH groups is modified to form a polypropylene oxide branch, wherein the propoxylated polyol comprises polypropylene oxide branches comprising on average at least four polypropylene oxide units.

The propoxylated polyols of the invention are based on polyols that have four to five —OH groups in total. The polyol core used to prepare the propoxylated polyols of the invention may be a monomer or may be oligo- or polymer build up by an assembly process comprising —OH groups containing subunits. Also, in case the polyol core is based on an oligomer or polymer the total number of —OH groups is four to five, too. For sake of clarity, this means that the number of —OH groups in the inventive compound is not restricted to only four and five but can also be every decimal number between four and five.

For example, diglycerol possesses four —OH groups and triglycerol possesses five —OH groups. The skilled person understands that a polyglycerol (n=2 to 3) mixture of diglycerol and triglycerol can be prepared, wherein the (population of) polyol has a total number of —OH groups that lies between four and five. Depending on the ratio of diglycerol and the ratio of triglycerol any decimal number between four and five can be adjusted. Thus, in preferred embodiments, the propoxylated polyol of the invention has 4; 4.1; 4.2; 4.3; 4.4; 4.5; 4.6; 4.7; 4.8; 4.9 or 5 —OH groups. In more preferred embodiments, the number of —OH groups in the propoxylated polyol refers to an average number of a mixture of proxylated polyols each having mainly four or five —OH groups.

Thus, the propoxylated polyols of the invention may be a homomeric or heteromeric group of molecules based on polyols that have four to five —OH groups.

The term “—OH group”, as used herein, refers to hydroxyl groups, in particular alcohol groups. This also includes —OH groups in the context of aromatic structures, such as phenols. The term includes all alcohol groups independent of the status of its carbon atom. Thus, in the sense of the present invention primary, secondary as well as tertiary alcohols fall within the meaning of “—OH group”. For example, the —OH group may also be a sugar, such as a hexose (e.g. glucose, fructose etc.). However, in preferred embodiments, the propoxylated polyol has a linear backbone of carbon atoms. Not included within the scope of the term “—OH group” are —OH groups that are part of carboxylic acids.

In preferred embodiments, the polyol reacted with propoxylene oxide does not comprise further functional groups (such as amines, esters, carbonyl, carbonic acids, phosphate, sulfonate groups etc. and derivatives thereof) besides the —OH groups.

The compounds of the invention comprise side chains, polypropylene oxide branches, which are attached to carbon atoms of the —OH group of the polyol. The side chains are made up from propylene oxides. Typically, a side chain possesses on average 4 to 30 PO units. More detailed embodiments describing the different chain lengths are provided below.

It is noted that all such numbers are numbers “on average” meaning that such numbers refer to the average number for such unit per —OH group calculated based on all —OH groups of a propoxylated polyol.

It is to be emphasized that the reactions leading to the inventive compounds are statistical reactions, meaning there is never just one chemically exactly defined compound present, but an inventive propoxylated polyol always is a mixture of slightly deviating structures, all stemming from the same reaction within one reaction space; the difference of those structures clearly stemming from the facts that no reaction proceeds in exactly the same way and the same speed on all functional units, especially as the chemical reactivities of the functional units—here mainly those of the —OH groups, differs according to their environment, meaning that a primary alcohol group reacts differently than a secondary alcohol, and also the chemical environment of the groups may be different; this leads in an overall view to slightly deviating structures being present, and thus any compound of this invention being defined as in the various embodiments including the numbered Embodiments 1 to 29, and exemplified in the examples never is just one chemical compound, but always a mixture of slightly deviating compounds, having a statistical distribution. As the reactivities of those groups are not differing by a large extent, the deviation is relatively small. Hence, defining a propoxylated polyol of the invention by a prototypical member is a viable way of defining the structure. Also, defining the composition of the side chains by average numbers (including those variables defined in the present and following Embodiments based on the numbers of —OH groups being present in the propoxylated polyols is a useful way of defining the overall composition of any mixture herein defined as “a propoxylated polyol of the invention”.

Therefore, unless otherwise indicated, the values, ranges and ratios given in the specification for the number of —OH groups and the molecular weight (Mn) relate to the number average values in heterogenic mixture of the synthesized propoxylated polyols containing individual, slightly from each other deviating chemical structures that result from the preparation method of the present invention. As known in polymer science, the weight-average molecular weight (Mw) is then a measure for the (in)homogeneity within the mixture of different species in “the propoxylated polyols”.

The presence of propylene oxides within or next to the (predominately) hydrophobic polyol core leads to an amphiphilic nature and thus to excellent cleaning properties of the inventive compounds in detergent applications. Inventive compounds bearing such modification are also called being “alkoxylated”, “propoxylated” and/or “modified”.

The terms “essentially consisting of” or “consisting essentially of”, as used interchangeably herein, with respect to the polyol mean that the polyol may comprise impurities or other types of polyols in an amount up to not more than 10% w/w, not more than 7% w/w, not more than 5% w/w, not more than 3% w/w, not more than 2% w/w, not more than 1% w/w, not more than 0.5% w/w or not more than 0.1% w/w.

### Embodiment 2

The propoxylated polyol according to Embodiment 1, wherein the polyol core is a monomer, oligomer or polymer, wherein each of the oligomer and the polymer comprise a plurality of subunits, preferably the oligomer is a homooligomer or the polymer is a heteropolymer.

The term “monomer”, as used herein, refers to a polyol which is not polymerized prior to its propoxylation. The term “oligomer”, as used herein, refers to molecules consisting of up to five repeating units including polyol repeating units, whereas the repeating units may be all the same or the oligomer consists of different repeating units. Thus, the oligomer includes dimers, trimers, tetramers and pentamers. Preferably, the oligomer is a “homooligomer” referring to an oligomer formed by identical monomers. The homooligomer is a compound formed by covalent bonding of a given polyol repeating unit. The term “polymer”, as used herein, refers to compounds that possess at least six repeating units which are covalently connected by a polymerization reaction. “Heteropolymer”, as used herein, refers to an organic polymer comprising two or more different repeating units including at least one polyol unit. The term “plurality”, as used herein, is defined as two or more than two, namely at least 2, 3, 4, 5, 6, 7, 8, 9 or more.

### Embodiment 3

The propoxylated polyol according to Embodiment 1 or 2, wherein the propoxylated polyol comprises polypropylene oxide branches comprising on average at least at least 5 polypropylene oxide units (POs), preferably at least 6 POs and more preferably at least 8 POs.

In even more preferred embodiments, the propylene oxide branches comprise on average at least 9, 10, 11, 12, 13, 14, 15 or more POs.

In preferred embodiments, one propylene oxide branch has an average weight ranging from 600 to 5500 g/mol, preferably from 1000 to 4000 g/mol and more preferably from 1500 to 3000 g/mol.

### Embodiment 4

The propoxylated polyol according to anyone of Embodiments 1 to 3, wherein the propoxylated polyol comprises polypropylene oxide branches comprising on average not more than 30 POs, preferably not more than 25 POs and more preferably not more than 22 POs. In even more preferred embodiments, the propylene oxide branches comprise on average not more than 21, 20, 19, 18, 17, 16 or less POs.

### Embodiment 5

The propoxylated polyol according to anyone of Embodiments 1 to 4, wherein the polyol core has a weight ranging from 90 to 500 g/mol, preferably from 100 to 300 g/mol and more preferably from 120 to 250 g/mol.

Methods to measure the weight of a polyol are well-known in the art and include mass spectrometry, mass photometry and static light scattering.

### Embodiment 6

The propoxylated polyol according to anyone of Embodiments 1 to 5, wherein the propoxylated polyol has a structure such that F is 0 or greater than 0 for Formula (1) and/or Formula (11), wherein:
Formula (1) is:

$$F = 2.7 \; 69 PQ - 12.46 P - 0.209 QX + 0.524 Q + 0.726 X + 1 ; and$$

Formula (11) is:

$$F = 0.1 \; 123 PQ - 0.505 P + 0 \text{.0027} QX - 0.2 \; 09 Q - 0.018 X + 1 ;$$

wherein
X=the average number of POs per propylene oxide branch;
P=the average number of ether linkages in the polyol core; and
Q=the average number of —OH groups in the polyol core.

It is noted that Formula (1) and (11) are based on the experimentally tested biodegradability of almost 30 compounds, whereas a value of 0 or more in Formula (1) is indicative for at least 40% biodegradability within 28 days according to the OECD 301F test and a value of 0 or more in Formula (11) is indicative for at least 60% biodegradability within 28 days according to the OECD 301F test.

The term “average number of POs per propylene oxide branch”, as used herein, refers to the calculated number of PO units that should be present in one propoxylene oxide branch. As explained in more detail above, the skilled person is well-aware of the fact that the synthesis of the inventive compounds will result in a mixture of slightly deviating compounds underlying a statistical distribution. Thus, the “average number of POs per propylene oxide branch” is calculated by dividing the total amount of employed mol PO per mol of polyol by the (average) number of —OH groups of the polyol (or the mixture of polyols).

The term “average number of ether linkages in the polyol core”, as used herein, refers to the calculated number of ether bonds that are present in one polyol molecule. As the polyol may be a mixture of deviating compounds, the “average number” may refer to the arithmetic average derived from the polyols of the mixture. For example, diglycerol has 1 ether linkage, triglycerol has 2 ether linkages. Polyglycerol with 50% diglycerol and 50% triglycerol has on average 1.5 ether linkages.

The term “average number of —OH groups in the polyol core”, as used herein, refers to the calculated number of —OH groups that should be present in one polyol molecule. As the polyol may be a mixture of deviating compounds, the “average number” may refer to the arithmetic average derived from the polyols of the mixture.

In preferred embodiments, the propoxylated polyol of the invention demonstrates at least 40%, preferably at least 50% or more preferably at least 60% biodegradability according to standard OECD 301F within 56 days, preferably within 28 days.

For the purposes of this invention, aerobic biodegradation in wastewater according to OECD 301F is expressed as a percentage of the theoretical oxygen demand (ThOD, which is measured by the elemental analysis of the compound of interest), which is needed to completely biodegrade the compound sample. Thus, the amount of oxygen taken up by the microbial population during biodegradation of the test substance (corrected for uptake by blank inoculum, run in parallel) is expressed as a percentage of ThOD. The obtained values are preferably measured in triplicate using the OECD 301F manometric respirometry method. The consumption of oxygen is determined by measuring the change in pressure in the apparatus using an OxiTop® C (Xylem 35 Analytics Germany Sales GmbH & Co KG). Details for the tests performed are given in the experimental section below.

The present invention provides modified polyols, which are propoxylated. The combined core-shell-product (i.e., the propoxylated polyol), in which the “core” is the polyol core, and the “shell” is the polypropylene oxide branches, exhibits a significant biodegradation value. Moreover, these inventive compounds demonstrate also wash performance comparable to currently used products.

### Embodiment 7

The propoxylated polyol according to anyone of Embodiments 1 to 6, wherein the weight average molecular weight (Mw) of the propoxylated polyol is in the range of from 700 to 6.000 g/mol, preferably in the range of from 1.500 to 4.000 g/mol, more preferably in the range of from 2.000 to 3500 g/mol.

The person skilled in the art knows how to determine/measure the respective weight average molecular weight (Mw). This can be done, for example, by size exclusion chromatography (such as GPC, e.g., in combination with light scattering). Preferably, Mw values are determined by the method as follows: OECD TG 118 (1996), which means in detail OECD (1996), Test No. 118: Determination of the Number-Average Molecular Weight and the Molecular Weight Distribution of Polymers using Gel Permeation Chromatography, OECD Guidelines for the Testing of Chemicals, Section 1, OECD Publishing, Paris, also available on the internet, for example, under https://doi.org/10.1787/9789264069848-en.

Molecular weights of the polyol starting materials may be determined as described above. Molecular weights of the propoxylated polyol may be determined by gel permeation chromatography (GPC). The samples were prepared as follows: approx. 15 mg sample was dissolved in 10 ml eluent (THF+0.035 mol/L Diethanolamine) for 1 hour at a temperature of 50 °C. All sample solutions were filtered by a Chromafil Xtra PTFE (0.20 μm filtered prior to injection). Sealed sample vials were placed into the auto sampler. An Agilent 1200 HPLC system, consisting of an isocratic pump, vacuum degasser, auto sampler and a column oven was used. Furthermore, the Agilent system contains a Differential Refractive Index (DRI) and a variable Ultra Violet (UVW) Detector for detection. Data acquisition and data processing of conventionally SEC data was done by WinGPC Unichrom, build 6999, of PSS (Polymer Standard Services now part of Agilent). A combination of a SDV guard (7.5×50 mm) column and 3 SDV columns (1000 A, 100000 A and 1000000 A, all 7.5×300 mm) of PSS were put in series at 60 °C. THE+0.035 mol/L Diethanolamine was used as eluent at a flow rate of 1 mL/min. 100 μL of each sample solution was injected. The calibration was obtained by narrow molar mass distributed Polyethyleneoxide standards (Agilent) having a molar mass range of M=160 till M=1.378.000 g/mol. Molar masses outside this range were extrapolated. “Mw” is the weight average molecular weight and “Mn” is number average molecular weight.

The respective values of Mw and/or Mn can be determined as described within the experimental section below.

The molar mass distribution Mw/Mn obtained by GPC is equal to the polydispersity index (PDI), the PDI being without unit [g/mol/g/mol]).

### Embodiment 8

The propoxylated polyol according to anyone of Embodiments 1 to 7, wherein the polyol core is selected from the group consisting of meso-Erythritol, D-threitol, L-threitol, 1,2,5,6-hexanetetrol, pentaerythritol, xylitol, ribitol, arabitol, pentitol, diglycerol, triglycerol, and polyglycerol and wherein the polyglycerol preferably consists of two to three subunits of glycerol.

In preferred embodiments, the term “polyglycerol”, as used herein, refers to a mixture of mainly diglycerol and triglycerol. The ratio of diglycerol to triglycerol may vary between 100:1 to 1:100. In further preferred embodiments, the mixture may also contain glycerol, tetraglycerol or pentaglycerol, all in a minor amount (not more than 5, 3 or 1% w/w of the polyglycerol mixture).

The skilled person will understand that the polyols may also be alkoxylated with other AOs than propoxylene oxide. In this context, ethylene oxide and butylene oxide are mentioned. Further, the skilled person is also well-aware of helpful modifications of the alkoxy chain, such as modifications with lactones or hydroxy carbon acid as described in WO2021165468 A.

It is noted that the alkylene oxide used to prepare the inventive compounds may be derived from a fossil or non-fossil carbon source or even a mixture of the before mentioned. Preferably, the amount of non-fossil carbon atoms in the alkoxy side chains is at least 10%, at least 20%, at least 40%, at least 70%, at least 95% or it solely comprises non-fossil derived carbon atoms. The skilled person is well-aware of commercial alkylene oxide products made of non-fossil carbon sources (these products are often sold as being sustainable, renewable or bio-based). For example, Croda International, Snaith, UK, sells ethylene oxide and related products based on bio-ethanol as ECO Range. Additionally, methods to prepare bio-based propylene oxide are also known (see Abraham, D. S., “Production of propylene oxide from propylene glycol” Master's Thesis University of Missouri-Columbia (2007) (75 pages)).

### Embodiment 9

The propoxylated polyol according to anyone of Embodiments 1 to 8, wherein the amount of secondary alcohol groups in the propoxylated polyol is in the range of from 30 to 100%, preferably from 75 to 99% and more preferably from 95 to 98%.

The inventive compounds comprise secondary alcohols that originate i) from primary alcohol groups of the polyol which are modified with a propoxylene oxide branch or ii) from non-reacted secondary alcohol groups of the polyol. By secondary alcohol, as used herein, an alcohol is meant in which the hydroxyl carbon is attached is attached to two other carbon atoms. Another hand, the inventive compounds may comprise tertiary alcohols that originate from non-reacted tertiary alcohol groups of the polyol. Primary alcohol groups in the inventive compound, if present, result from non-reacted primary alcohol groups of the polyol.

The amount of secondary alcohol group in the propxylated polyol can be measured according to methods known to the skilled person, such as NMR-spectroscopy, such as 13C-NMR-spectroscopy and/or 1H NMR-spectroscopy. Additionally, the amount of secondary alcohols groups can be measured by modification of the propoxylated polyols with trichloroacetyl isocyanate and determination of modified secondary and primary alcohol groups in 1H-NMR spectra in CDCl3. The method is described in: J. Loccufier et al., Polymer Bulletin 27, 201-204 (1991).

“Amount of secondary alcohol groups in the propoxylated polyol”, as used herein, is defined as a percentage of versus the total amount of OH groups (i.e. the amount of secondary OH groups divided by the total amounts of OH groups). For example, the polymer has 4 secondary OH groups and 1 primary OH group, therefore the “amount of secondary alcohol groups in the propoxylated polyol” is 4/(4+1)=80%.

### Embodiment 10

The propoxylated polyol according to Embodiment 9, wherein the amount of secondary alcohol groups in the propoxylated polyol based on the indicated polyols is in the ranges as follows: meso-Erythritol: 50 to 100%; D-threitol: 50 to 100%; L-threitol: 50 to 100%; 1,2,5,6-hexanetetrol: 50 to 100%; pentaerythritol: 30 to 100%; xylitol: 60 to 100%; ribitol: 60 to 100%; arabitol: 60 to 100%; pentitol: 60 to 100%; and polyglycerol: 33 to 100%.

It is noted that in preferred embodiments, the polyol core at least comprises two “terminal” primary alcohol groups. In addition to these two primary alcohols, the polyol further possesses two or three secondary alcohol groups.

### Embodiment 11

The propoxylated polyol according to any of Embodiments 1 to 10, wherein all propoxylene oxide branches attached to the —OH group of the polyol have the same structure, in that sense that the number of PO units per propoxylene oxide branch is identical or, alternatively, the propoxylene oxide branch structures vary.

Without wishing being bound by the following explanation, a rationale exists to explain the resulting structures of the propoxylated polyols: Due to the fact that the reactions in questions necessarily employed to prepare those structural orders of the side chains, and thus to prepare the specific inventive compounds, are reactions of quite reactive species which can lead under suitable conditions to almost complete and even “essentially complete” conversions of almost 100% if not even 100%, the statistical deviation of the composition of the mixture of “propoxylated polyols” in question is not that high, which in turn means that the structural order of the side chains do not show much deviation. Thus, it is a reliable assumption which can in principle be proven by sophisticated and thus time-consuming and expensive analytical means—such as multi-dimensional NMR-analyses—that it is generally accepted that such deviation exists; hence, no “specific propoxylated polyol” will be “just one chemical compound of a clearly defined chemical structure”, but clearly will consist of a a) mixture of slightly differing compounds, such differences lying in b) slight deviations may already in the structure of compound making up “the (unmodified) polyol” being employed for the further modification steps, and c) the slight deviations in the structural orders of the side chains may be attached by way of d) multi-step reactions due to e) variations in the chemical reactivities of the —OH groups, and f) due to slight inhomogeneities occurring in a commercial scale process. All of those factors a) to f)—to just mention a few important ones—lead to a “specific propoxylated polyol” which is not one specific chemical compound but in fact a mixture of slightly differing compounds having an overall very similar chemical structure; thus, such structure is best described by average numbers for the variables and percentages for the amounts of the dominating structural order.

### Embodiment 12

A process for preparing the propoxylated polyol according to Embodiments 1 to 11, wherein a polyol essentially consisting of four to five —OH groups is reacted with at least 16 propylene oxide molecules in order to obtain the respective propoxylated polyol.

In more preferred embodiments, a polyol comprising four —OH groups is reacted with at least 16 propylene oxide molecules and a polyol comprising five —OH groups is reacted with at least 20 propylene oxide molecules. In general, the amount of propylene oxide molecules is chosen in a way that each —OH of the polyol comprises on average at least 4 propylene oxide molecules.

All of the terms within Embodiment 12 have already been defined and explained in detail herein before within the description of the Embodiments 1 to 11, such terms, definitions and further specifications of course apply to this Embodiment 12.

The conversion rate of the reaction step may be monitored and in preferred embodiments the conversion rate is at least 90%, preferably at least 95%, more preferably at least 99%, and even more preferably at least 99.5% or even more. All other structural orders of the side chains as defined above but also the undefined structures resulting from non-controllable parameters are performed in this defined manner, leading—on statistical average—to a defined structural order directly derived from the way such reaction is performed.

The conversion rate of the reaction can be determined according to methods known to the skilled person, such as NMR-spectroscopy, such as 13C-NMR-spectroscopy and/or 1H NMR-spectroscopy.

For the reaction conditions such as catalysts, temperatures, duration, purification etc. of the reactions to produce the units of the side chains of the inventive propoxylated polyols, the respective information within the disclosures EP3298120 A, JP2022056680 A and U.S. Pat. No. 7,468,348 B is fully encompassed into this recent disclosure by way of reference.

Within this preferred Embodiment, the alkoxylation/propoxylation is carried out in the presence of at least one catalyst. Within this single step reaction of the alkoxylation step, the catalyst is preferably a basic catalyst. Examples of suitable catalysts are alkali metal and alkaline earth metal hydroxides such as sodium hydroxide, potassium hydroxide and calcium hydroxide, alkali metal alkoxides, in particular sodium and potassium C₁-C₄-alkoxides, such as sodium methoxide, sodium ethoxide and potassium tert-butoxide, alkali metal and alkaline earth metal hydrides such as sodium hydride and calcium hydride, and alkali metal carbonates such as sodium carbonate and potassium carbonate. Preference is given to the alkali metal hydroxides and the alkali metal alkoxides, a particular preference being given to potassium hydroxide and sodium hydroxide. Typical use amounts for the base are from 0.05 to 10% by weight of final product, in particular from 0.05 to 2% by weight, based on the total amount of polyol and propylene oxide.

### Embodiment 13

The process according to Embodiment 12, wherein the polyol possessing four to five —OH groups is selected from the group consisting of meso-Erythritol, D-threitol, L-threitol, 1,2,5,6-hexanetetrol, pentaerythritol, xylitol, ribitol, arabitol, pentitol, diglycerol, triglycerol, and polyglycerol, preferably consisting of two to three subunits of glycerol.

### Embodiment 14

Process according to Embodiment 12 or 13, wherein the propoxylated polyol is further submitted to the following process steps of
a. purification using standard means such as steam distillation, thermal distillation, vacuum evaporation, including removal of all solvent, dialysis and/or
b. drying using standard drying means such as spray-, drum, paddle-, vacuum-drying means including agglomeration methods such as fluidized-bed-drying,
   to obtain a purified solution, a purified liquid, a solid compound or a purified solid compound, respectively.

In case that after the reaction leading to the inventive compound residual educts (polyol and/or propylene oxide) are present to a non-desirable extent, the resulting product mixture containing the propoxylated polyol may be further purified by standard means to reduce the content of residual educts, but also to reduce the amount of possible by-products, reduce the amount(s) of the solvent(s) employed (i.e., to concentrate) or replace solvent(s) with other solvents. Such processes are known to a person of skill in this field.

Preferably, undesirable amounts of residual non-reacted educts are removed, preferably by means of distillative processes, more preferably by thermal distillative processes, which may additionally comprise the application of reduced pressure to increase the speed and/or the effectiveness of the removal.

In a preferred embodiment only the additional process step a) is employed.

### Use of and Compositions Comprising the Inventive Propoxylated Polyols

Part of this invention is also the use of the inventive propoxylated polyols for various fields of applications, where they can replace currently known similar structures, but bring in their enhanced rate of biodegradation compared to those previously known structures.

### Embodiment 15

Use of at least one propoxylated polyol according to any one of Embodiments 1 to 11 in cleaning compositions, in fabric and home care products, in cosmetic formulations, as crude oil emulsion breaker, in pigment dispersions for ink jet inks, in formulations for electro plating, in cementitious compositions, as dispersant for agrochemical formulations.

A subject matter of the present invention is the use of the above-mentioned propoxylated polyol in fabric and home care products, in cosmetic formulations, as crude oil emulsion breaker, in pigment dispersions for ink jet inks, in formulations for electro plating, in cementitious compositions and/or as dispersant for agrochemical formulations, preferably in cleaning compositions and/or in fabric and home care products, in particular cleaning compositions for improved clay removal or oily and fatty stain removal, wherein the cleaning composition is preferably a laundry detergent formulation and/or a manual dish wash detergent formulation, more preferably a liquid laundry detergent formulation and/or a liquid manual dish wash detergent formulation.

The propoxylated polyol can be added to cosmetic formulations, as crude oil emulsion breaker, in pigment dispersions for ink jet inks, formulations for electro plating, in cementitious compositions. However, the inventive compounds can also be added to (used in) washing or cleaning compositions.

Another subject-matter of the present invention is, therefore, a cleaning composition, fabric and home care product, industrial and institutional cleaning product, cosmetic formulation, crude oil emulsion breaker, pigment dispersion for ink jet inks, formulation for electro plating, cementitious composition and/or dispersant for agrochemical formulations, comprising at least one propoxylated polyol, as defined above.

Preferably, it is a cleaning composition and/or fabric and home care product, comprising at least one propoxylated polyol, as defined above, preferably for improved clay removal or oily and fatty stain removal, or sebum and body soil removal, preferably a laundry detergent formulation and/or a manual dish wash detergent formulation, more preferably a liquid laundry detergent formulation and/or a liquid manual dish wash detergent formulation.

In another preferred embodiment of the present invention, the cleaning composition may be used for soil removal of particulate stains and/or oily and fatty stains, and additionally for whiteness maintenance, preferably in laundry care.

In another embodiment, the cleaning composition of the present invention is a hard surface cleaning composition that may be used for cleaning various surfaces such as hard wood, tile, ceramic, plastic, leather, metal, glass.

In another embodiment, the cleaning composition of the present invention is a liquid or solid automatic dish wash detergent composition, preferably a solid automatic dish wash detergent composition, that may be used for cleaning dish ware, e.g., dish ware such as glasses, wherein the inventive propoxylated polyol is improving the removal of stubborn soils.

In another embodiment, the cleaning composition is designed to be used in personal care and pet care compositions such as shampoo compositions, body wash formulations, liquid or solid soaps.

In this invention, a preferred area of application for the use of the propoxylated polyol is the field of fabric and home care products and cleaning compositions, preferably cleaning compositions for industrial and institutional use and the use by consumers in their household.

### Embodiment 16

The use according to Embodiment 15 in cleaning compositions and/or in fabric and home care products, preferably in liquid and solid detergent compositions, such detergent compositions preferably being
a) manual and automatic dish wash detergent compositions, comprising the at least one propoxylated polyol, and the at least one chelating agent and/or the at least one surfactant or—more preferably—a chelating agent in case of a liquid or solid automatic dish wash composition and a surfactant system in case of a liquid manual dish wash detergent composition, respectively; and/or
b) laundry detergent compositions comprising the at least one propoxylated polyol, and at least one surfactant or—preferably—a surfactant system.

Within such preferred application areas of use, typical tasks have to be fulfilled, all of which are commonly encompassed by the term “cleaning”, but in fact comprise different tasks such as clay removal or removing oily and fatty residues, solid residues, amphiphilic residues and hydrophilic residues. Other tasks are the protection of the goods to be cleaned from deterioration, such as protecting glass from corroding, silverware from oxidation, colors from fading etc. Other tasks are improving the overall appearance of the to be cleaned goods, such as increasing or restoring the color, the whiteness, imparting or increasing a shine. For many such applications additional ingredients are typically added, for cleaning applications important ones are for example enzymes, which help biologically to degrade residues.

### Embodiment 17

The use according to Embodiment 15 or 16 for
i. clay removal, and/or
ii. improved removal of oily/fatty stains, and/or
iii. soil removal of particulate stains, and/or
iv. dispersion and/or emulsification of soils, and/or
v. modification of treated surface to improve removal upon later re-soiling, and/or
vi. whiteness improvement, and/or
most preferably in cleaning compositions for
i) clay removal and/or ii) removal of oily/fatty stains,
each of the before mentioned options i) to vi) preferably for use in a laundry detergent formulation and/or a manual dish wash detergent formulation and/or in a formulation suitable for (pre)-treatment of textiles and/or soap bars, more preferably in a liquid laundry detergent formulation and/or a liquid manual dish wash detergent formulation.

### Embodiment 18

The use according to any of Embodiments 15 to 17 in cleaning compositions and/or in fabric and home care products, preferably in cleaning compositions for fabric and home care, the cleaning composition preferably being a laundry detergent formulation or a dish wash detergent formulation, even more preferably being a liquid laundry detergent formulation or a liquid dish wash detergent formulation.

Such ingredients are typically formulated with other ingredients in formulations and compositions, which may be also called “products” (as they are provided from a supplier as a formulation to another customer who uses such formulation directly for cleaning purposes etc. or for producing another formulation, which in turn could be sold to consumers as a “product” to be used by the consumer).

### Embodiment 19

A composition that is a fabric and home care product, cleaning composition, industrial and institutional cleaning product, cosmetic or personal care product, oil field-formulation such as crude oil emulsion breaker, pigment dispersion for inks such as ink-jet inks, electro plating product, cementitious composition, lacquer, paint, agrochemical formulation, preferably a laundry detergent, a dish wash composition, a cleaning composition and/or a fabric and home care product, each comprising at least one propoxylated polyol according to any of the Embodiments 1 to 11 or obtained by or obtainable by a process according to any of Embodiments 12-14.

### Embodiment 20

A composition according to Embodiment 19 being a solid or liquid laundry detergent composition or a solid or liquid manual dish wash detergent composition, preferably a liquid laundry detergent or a liquid manual dish wash detergent composition, more preferably a liquid laundry detergent composition, comprising the least one propoxylated polyol according to any one of Embodiments 1 to 11 or obtained by or obtainable by a process according to any of Embodiments 12-14;
optionally further comprising at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate lyases, pectinases, lactases, pectate lyases, mannanases and peroxidases, and combinations of at least two of the foregoing types, preferably at least one enzyme being selected from proteases,
optionally containing at least one antimicrobial agent,
wherein at least one propoxylated polyol is present in an amount ranging from about 0.01% to about 20%, preferably from about 0.05% to 15%, more preferably from about 0.1% to about 10%, and most preferably from about 0.5% to about 5%, in relation to the total weight of such composition or product, and
such product or composition further comprising from about 1% to about 70% by weight of at least one surfactant, preferably an anionic surfactant, or even more preferably of a surfactant system comprising at least one anionic surfactant.

### Embodiment 21

A composition according to Embodiment 19 being a solid or liquid automatic dish wash detergent composition, preferably a solid automatic dish wash detergent composition, comprising the at least one propoxylated polyol according to any one of Embodiments 1 to 11 or obtained by or obtainable by a process according to any of Embodiments 12-14;
optionally further comprising at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate lyases, pectinases, lactases, pectate lyases, mannanases and peroxidases, and combinations of at least two of the foregoing types, preferably at least one enzyme being selected from proteases and amylases,
optionally containing at least one antimicrobial agent,
optionally containing at least one compound selected from alkali metal percarbonate, alkali metal perborate and alkali metal persulfate,
optionally containing at least one zinc salt,
wherein the at least one propoxylated polyol is being present in a total amount ranging from about 0.001% to about 10%, preferably from about 0.005% to 5%, more preferably from about 0.01% to about 3%, and most preferably from about 0.1% to about 2%, and such product or composition further comprising at least one chelating agent being present in a total amount from about 1% to about 70%, preferably from 10% to about 60% and even more preferably from 30% to about 50%, and
optionally further comprising at least one surfactant or more preferably a surfactant system in a total amount of from about 1% to about 70% by weight,
all weight percent in relation to the total weight of such composition.

### Embodiment 22

A composition according to Embodiment 21, being a solid automatic dish wash detergent composition, comprising the at least one propoxylated polyol according to any one of Embodiments 1 to 11 or obtained by or obtainable by a process according to any of Embodiments 12-14, and
additionally comprising at least one chelating agent selected from methylglycinediaceticacid (MGDA), glutamic acid diacetate (GLDA), citric acid and salts thereof,
at least one enzyme selected from proteases and/or amylases,
at least one bleaching agent selected from alkali metal percarbonate, alkali metal perborate and alkali metal persulfate, preferably alkali metal percarbonate, at least one non-ionic surfactant,
optionally at least one disintegrant, preferably a super-disintegrant, more preferably PVPP, and
optionally containing at least one zinc salt.

Super-disintegrants are known by a person of skill in the art, e.g. from EP1004661, EP1263814 and EP1036839, and are discussed also in Pharmaceutical Technology, Volume 2006 Supplement, Issue 5, “A Comparative Study of Current Superdisintegrants”, Oct. 1, 2006.

### Embodiment 23

Composition according to any of Embodiments 19 and 20 being a detergent composition, comprising as surfactant at least one anionic surfactant.

### Embodiment 24

Composition according to any of Embodiments 19 and 20 being a liquid detergent composition, comprising as surfactant at least one non-ionic surfactant, and further comprising water.

### Embodiment 25

Composition according to any of Embodiments 19, 20, 23 and 24 being a detergent composition, comprising at least one polymer selected from multifunctional alkoxylated polyethylene imines, multifunctional alkoxylated diamines or terephthalic acid-based soil release polyesters, or mixtures thereof.

### Embodiment 26

Composition according to any of Embodiments 19, 20 and 23 to 25 being a liquid detergent composition, comprising as surfactant at least one 2-propylheptyl ethoxylated non-ionic surfactant having an average degree of ethoxylation of from 3 to 8.

### Embodiment 27

Composition according to any one of Embodiments 19 to 26 further comprising an antimicrobial agent selected from the group consisting of 2-phenoxyethanol and 4,4′-dichoro 2-hydroxydiphenylether; preferably comprising 2-phenoxyethanol in an amount ranging from 2 ppm to 5% by weight of the composition; more preferably comprising 0.1 to 2% of phenoxyethanol or preferably comprising 4,4′-dichoro 2-hydroxydiphenylether in a concentration from 0.001 to 3%, more preferably 0.002 to 1%, even more preferably 0.01 to 0.6%, each by weight of the composition.

### Embodiment 28

Composition according to any one of Embodiments 19 to 27 further comprising at least one enzyme selected from the list consisting of lipases, hydrolases, amylases, DNases, proteases, cellulases, hemicellulases, phospholipases, esterases, mannanases, xylanases, dispersins, oxidoreductases, cutinases, pectate lyases, pectinases, lactases and peroxidases, and combinations of at least two of the foregoing types, preferably selected from one or more lipases, hydrolases, amylases, proteases, cellulases, and combinations of at least two of the foregoing types, more preferably at least one enzyme being selected from proteases.

### Embodiment 29

Method of preserving an aqueous composition according to any one of Embodiments 19 to 28 against microbial contamination or growth, which method comprises addition of an antimicrobial agent selected from the group consisting of 2-phenoxyethanol and 4,4′-dichoro 2-hydroxydiphenylether.

It is also preferred in the present invention that the cleaning composition comprises (besides at least one propoxylated polyol as described above) additionally at least one enzyme, preferably selected from one or more lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, preferably selected from one or more lipases, hydrolases, amylases, proteases, cellulases and combinations of at least two of the foregoing types, more preferably at least one enzyme being selected from proteases.

Preferably, the such inventive cleaning composition is a fabric and home care product or an industrial and institutional (I&I) cleaning product, preferably a fabric and home care product, more preferably a laundry detergent or manual dish washing detergent, comprising at least one inventive propoxylated polyol, and optionally further comprising at least one surfactant or a surfactant system, providing improved removal, dispersion and/or emulsification of soils and/or modification of treated surfaces and/or whiteness maintenance of treated surfaces.

At least one inventive propoxylated polyol as described herein (such propoxylated polyol as defined before and especially in the Embodiments 1 to 11 are in this following section also termed “inventive compound”) is present in said inventive cleaning compositions at a concentration of from about 0.01% to about 20%, preferably from about 0.05% to 15%, more preferably from about 0.1% to about 10%, and most preferably from about 0.5% to about 5%, in relation to the total weight of such composition or product; such cleaning composition may—and preferably does—further comprise a from about 1% to about 70% by weight of a surfactant system.

Even more preferably, the cleaning compositions of the present invention comprising at least one inventive compound, and optionally further comprising at least one surfactant or a surfactant system, are those for primary cleaning (i.e., removal of stains) within laundry and manual dish wash applications, even more specifically, for removal of clay or oily and fatty stains such as those on fabrics and dishware, and may additionally comprise at least one enzyme selected from the list consisting of lipases, hydrolases, amylases, proteases, cellulases, hemicellulases, phospholipases, esterases, DNases, mannanases, xylanases, dispersins, oxidoreductases, cutinases, pectate lyases, pectinases, lactases and peroxidases, and combinations of at least two of the foregoing types of enzymes, more preferably at least one enzyme being selected from proteases.

In one preferred embodiment, the cleaning composition of the present invention is a liquid or solid laundry detergent composition.

In another preferred embodiment, the cleaning composition of the present invention is a liquid or solid (e.g., powder or tab/unit dose) detergent composition for manual or automatic dish wash, preferably either a liquid manual dish wash detergent composition or a solid automatic dish wash composition.

In one embodiment, the inventive compounds of the present invention may be utilized in cleaning compositions comprising a surfactant system comprising C₁₀-C₁₅ alkyl benzene sulfonates (LAS) as the primary surfactant and one or more additional surfactants selected from non-ionic, cationic, amphoteric, zwitterionic or other anionic surfactants, or mixtures thereof.

In a further embodiment, the inventive compounds may be utilized in cleaning compositions, such as laundry detergents of any kind, and the like, comprising C₈-C₁₈ linear or branched alkyl ether sulfates with 1-5 ethoxy-units as the primary surfactant and one or more additional surfactants selected from non-ionic, cationic, amphoteric, zwitterionic or other anionic surfactants, or mixtures thereof.

In a further embodiment the inventive compounds may be utilized in cleaning compositions, such as laundry detergents of any kind, and the like, comprising C₁₂-C₁₈ alkyl ethoxylate surfactants with 5-10 ethoxy-units as the primary surfactant and one or more additional surfactants selected from anionic, cationic, amphoteric, zwitterionic or other non-ionic surfactants, or mixtures thereof.

In a further embodiment the inventive compounds may be utilized in cleaning compositions, such as laundry detergents of any kind, and the like, comprising bio-based surfactants like rhamnolipids and/or sophorolipids as the primary surfactant.

In one embodiment of the present invention, the inventive compound is a component of a cleaning composition, such as preferably a laundry or a dish wash formulation, more preferably a liquid laundry or manual dish wash formulation, that each additionally comprise at least one surfactant, preferably at least one anionic surfactant.

The selection of the additional surfactants in these embodiments may be dependent upon the application and the desired benefit.

As used herein, the articles “a” and “an” when used in a claim or an embodiment, are understood to mean one or more of what is claimed or described. As used herein, the terms “include(s)” and “including” are meant to be non-limiting, and thus encompass more than the specific item mentioned after those words.

The compositions of the present disclosure can “comprise” (i.e., contain other ingredients), “consist essentially of” (comprise mainly or almost only the mentioned ingredients and other ingredients in only very minor amounts, mainly only as impurities), or “consist of” (i.e., contain only the mentioned ingredients and in addition may contain only impurities not avoidable in a technical environment, preferably only the ingredients) the components of the present disclosure.

The term “at least one”, as used herein, includes but is not limited to 1, 2, 3, 4, 5, 6, 7, 8, 9 and more.

Similarly, the terms “substantially free of . . . ” or “substantially free from . . . ” or “(containing/comprising) essentially no . . . ” may be used herein; this means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or even less than 0.1%, or even more less than 0.01%, or even 0%, by weight of the composition.

The term “about”, as used herein, encompasses the exact number “X” mentioned as e.g., “about X %” etc., and small variations of X, including from minus 5 to plus 5% deviation from X (with X for this calculation set to 100%), preferably from minus 2 to plus 2%, more preferably from minus 1 to plus 1%, even more preferably from minus 0.5 to plus 0.5% and smaller variations. Of course, if the value X given itself is already “100%” (such as for purity etc.) then the term “about” clearly can and thus does only mean deviations thereof which are smaller than “100”.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (°C) unless otherwise indicated. Unless otherwise specified, all measurements herein are conducted at 20 °C and under atmospheric pressure. In all embodiments of the present disclosure, all percentages are by weight of the total composition, unless specifically stated otherwise. All ratios are weight ratios, unless specifically stated otherwise.

Description of Cleaning Compositions, Formulations and their Ingredients

The phrase “cleaning composition” as used herein includes compositions and formulations designed for cleaning soiled material. Such compositions and formulations include those designed for cleaning soiled material or surfaces of any kind.

Compositions for “industrial and institutional cleaning” includes such cleaning compositions being designed for use in industrial and institutional cleaning, such as those for use of cleaning soiled material or surfaces of any kind, such as hard surface cleaners for surfaces of any kind, including tiles, carpets, PVC-surfaces, wooden surfaces, metal surfaces, lacquered surfaces.

“Compositions for Fabric and Home Care” include cleaning compositions and formulations including but not limited to laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, dish washing compositions, hard surface cleaning compositions, unit dose formulation, delayed delivery formulation, detergent contained on or in a porous substrate or nonwoven sheet, and other suitable forms that may be apparent to one skilled in the art in view of the teachings herein and detailed herein below when describing the compositions. Such compositions may be used as a pre-laundering treatment, a post-laundering treatment, or may be added during the rinse or wash cycle of the laundering operation, preferably during the wash cycle of the laundering or dish washing operation, and as further detailed herein below when describing the use and application of the inventive compounds and compositions comprising such polymers.

The cleaning compositions of the invention may be in any form, namely, in the form of a liquid; a solid such as a powder, granules, agglomerate, paste, tablet, pouches, bar, gel; an emulsion; types delivered in dual- or multi-compartment containers; single-phase or multi-phase unit dose; a spray or foam detergent; premoistened wipes (i.e., the cleaning composition in combination with a nonwoven material such as that discussed in U.S. Pat. No. 6,121,165, Mackey, et al.); dry wipes (i.e., the cleaning composition in combination with a nonwoven materials, such as that discussed in U.S. Pat. No. 5,980,931, Fowler, et al.) activated with water by a user or consumer; and other homogeneous, non-homogeneous or single-phase or multiphase cleaning product forms.

The liquid cleaning compositions of the present invention preferably have a viscosity of from 50 to 10000 mPa*s; liquid manual dish wash cleaning compositions (also liquid manual “dish wash compositions”) have a viscosity of preferably from 100 to 10000 mPa*s, more preferably from 200 to 5000 mPa*s and most preferably from 500 to 3000 mPa*s at 20 1/s and 20 °C; liquid laundry cleaning compositions have a viscosity of preferably from 50 to 3000 mPa*s, more preferably from 100 to 1500 mPa*s and most preferably from 200 to 1000 mPa*s at 20 1/s and 20 °C.

The liquid cleaning compositions of the present invention may have any suitable pH-value. Preferably the pH of the composition is adjusted to between 4 and 14. More preferably the composition has a pH of from 6 to 13, even more preferably from 6 to 10, most preferably from 7 to 9. The pH of the composition can be adjusted using pH modifying ingredients known in the art and is measured as a 10% product concentration in demineralized water at 25 °C. For example, NaOH may be used and the actual weight % of NaOH may be varied and trimmed up to the desired pH such as pH 8.0. In one embodiment of the present invention, a pH>7 is adjusted by using amines, preferably alkanolamines, more preferably triethanolamine.

Cleaning compositions such as fabric and home care products and formulations for industrial and institutional cleaning, more specifically such as laundry and manual dish wash detergents, are known to a person skilled in the art. Any composition etc. known to a person skilled in the art, in connection with the respective use, can be employed within the context of the present invention by including at least one inventive compound, preferably at least one polymer in amounts suitable for expressing a certain property within such a composition, especially when such a composition is used in its area of use.

One aspect of the present invention is also the use of the inventive compounds as additives for detergent formulations, particularly for liquid detergent formulations, preferably concentrated liquid detergent formulations, or single mono doses for laundry.

The cleaning compositions of the invention may—and preferably do—contain adjunct cleaning additives (also abbreviated herein as “adjuncts”), such adjuncts being preferably in addition to a surfactant system as defined before.

Suitable adjunct cleaning additives include builders, cobuilders, structurants or thickeners, clay soil removal/anti-redeposition agents, polymeric soil release agents, dispersants such as polymeric dispersing agents, polymeric grease cleaning agents, solubilizing agents, chelating agents, enzymes, enzyme stabilizing systems, bleaching compounds, bleaching agents, bleach activators, bleach catalysts, brighteners, malodor control agents, pigments, dyes, opacifiers, hueing agents, dye transfer inhibiting agents, chelating agents, suds boosters, suds suppressors (antifoams), color speckles, silver care, anti-tarnish and/or anti-corrosion agents, alkalinity sources, pH adjusters, pH-buffer agents, hydrotropes, scrubbing particles, antibacterial agents, anti-oxidants, softeners, carriers, processing aids, pro-perfumes, dye fixation agent and perfumes.

Liquid cleaning compositions additionally may comprise—and preferably do comprise at least one of—rheology control/modifying agents, emollients, humectants, skin rejuvenating actives, and solvents.

Solid compositions additionally may comprise—and preferably do comprise at least one of—fillers, bleaches, bleach activators and catalytic materials.

Suitable examples of such cleaning adjuncts and levels of use are found in WO 99/05242, U.S. Pat. Nos. 5,576,282, 6,306,812 B1 and 6,326,348 B1.

Those of ordinary skill in the art will understand that a detersive surfactant encompasses any surfactant or mixture of surfactants that provide cleaning, stain removing, or laundering benefit to soiled material.

Hence, the cleaning compositions of the invention such as fabric and home care products, and formulations for industrial and institutional cleaning, more specifically such as laundry and manual dish wash detergents, preferably additionally comprise a surfactant system and, more preferably, also further adjuncts, as the one described above and below in more detail.

The surfactant system may be composed from one surfactant or from a combination of surfactants selected from anionic surfactants, non-ionic surfactants, cationic surfactants, zwitterionic surfactants, amphoteric surfactants, and mixtures thereof. Those of ordinary skill in the art will understand that a surfactant system for detergents encompasses any surfactant or mixture of surfactants that provide cleaning, stain removing, or laundering benefit to soiled material.

The cleaning compositions of the invention preferably comprise a surfactant system in an amount sufficient to provide desired cleaning properties. In some embodiments, the cleaning composition comprises, by weight of the composition, from about 1% to about 70% of a surfactant system. In other embodiments, the liquid cleaning composition comprises, by weight of the composition, from about 2% to about 60% of the surfactant system. In further embodiments, the cleaning composition comprises, by weight of the composition, from about 5% to about 30% of the surfactant system. The surfactant system may comprise a detersive surfactant selected from anionic surfactants, non-ionic surfactants, cationic surfactants, zwitterionic surfactants, amphoteric surfactants, and mixtures thereof.

### (a) Laundry Compositions

In laundry formulations, anionic surfactants contribute usually by far the largest share of surfactants within such formulation. Hence, preferably, the inventive cleaning compositions for use in laundry comprise at least one anionic surfactant and optionally further surfactants selected from any of the surfactant classes described herein, preferably from non-ionic surfactants and/or amphoteric surfactants and/or zwitterionic surfactants and/or cationic surfactants.

Nonlimiting examples of anionic surfactants—which may be employed also in combinations of more than one surfactant—useful herein include C₉-C₂₀ linear alkylbenzenesulfonates (LAS), C₁₀-C₂₀ primary, branched chain and random alkyl sulfates (AS); C₁₀-C₁₈ secondary (2,3) alkyl sulfates; C₁₀-C₁₈ alkyl alkoxy sulfates (AExS) wherein x is from 1 to 30; C₁₀-C₁₈ alkyl alkoxy carboxylates comprising 1 to 5 ethoxy units; mid-chain branched alkyl sulfates as discussed in U.S. Pat. Nos. 6,020,303 and 6,060,443; mid-chain branched alkyl alkoxy sulfates as discussed in U.S. Pat. Nos. 6,008,181 and 6,020,303; modified alkylbenzene sulfonate (MLAS) as discussed in WO 99/05243, WO 99/05242 and WO 99/05244; methyl ester sulfonate (MES); and alpha-olefin sulfonate (AOS).

Preferred examples of suitable anionic surfactants are alkali metal and ammonium salts of C₈-C₁₂-alkyl sulfates, of C₁₂-C₁₈-fatty alcohol ether sulfates, of C₁₂-C₁₈-fatty alcohol polyether sulfates, of sulfuric acid half-esters of ethoxylated C₄-C₁₂-alkylphenols (ethoxylation: 3 to 50 mol of ethylene oxide/mol), of C₁₂-C₁₈-alkylsulfonic acids, of C₁₂-C₁₈ sulfo fatty acid alkyl esters, for example of C₁₂-C₁₈ sulfo fatty acid methyl esters, of C₁₀-C₁₈-alkylarylsulfonic acids, preferably of n-C₁₀-C₁₈-alkylbenzene sulfonic acids, of C₁₀-C₁₈ alkyl alkoxy carboxylates and of soaps such as for example C₈-C₂₄-carboxylic acids. Preference is given to the alkali metal salts of the aforementioned compounds, particularly preferably the sodium salts.

In one embodiment of the present invention, anionic surfactants are selected from n-C₁₀-C₁₈-alkylbenzene sulfonic acids and from fatty alcohol polyether sulfates, which, within the context of the present invention, are in particular sulfuric acid half-esters of ethoxylated C₁₂-C₁₈-alkanols (ethoxylation: 1 to 50 mol of ethylene oxide/mol), preferably of n-C₁₂-C₁₈-alkanols.

In one embodiment of the present invention, also alcohol polyether sulfates derived from branched (i.e., synthetic) C₁₁-C₁₈-alkanols (ethoxylation: 1 to 50 mol of ethylene oxide/mol) may be employed.

Preferably, the alkoxylation group of both types of alkoxylated alkyl sulfates, based on C₁₂-C₁₈-fatty alcohols or based on branched (i.e., synthetic) C₁₁-C₁₈-alcohols, is an ethoxylation group and an average ethoxylation degree of any of the alkoxylated alkyl sulfates is 1 to 5, preferably 1 to 3.

In a further embodiment of the present invention, anionic surfactants are selected from rhamnolipids and/or sophorolipids.

Preferably, the laundry detergent formulation of the present invention comprises from at least 1 wt. % to 50 wt. %, preferably in the range from greater than or equal to about 2 wt. % to equal to or less than about 30 wt. %, more preferably in the range from greater than or equal to 3 wt. % to less than or equal to 25 wt. %, and most preferably in the range from greater than or equal to 5 wt. % to less than or equal to 25 wt. % of one or more anionic surfactants as described above, based on the particular overall composition, including other components and water and/or solvents.

In a preferred embodiment of the present invention, anionic surfactants are selected from C₁₀-C₁₅ linear alkylbenzenesulfonates, C₁₀-C₁₈ alkylethersulfates with 1-5 ethoxy units and C₁₀-C₁₈ alkylsulfates.

Non-limiting examples of non-ionic surfactants—which may be employed also in combinations of more than one other surfactant—include: C₈-C₁, alkyl ethoxylates, such as, NEODOL® non-ionic surfactants from Shell; ethylenoxide/propylenoxide block alkoxylates as PLURONIC® from BASF; C₁₄-C₂₂ mid-chain branched alkyl alkoxylates, BAEx, wherein x is from 1 to 30, as discussed in U.S. Pat. Nos. 6,153,577, 6,020,303 and 6,093,856; alkylpolysaccharides as discussed in U.S. Pat. No. 4,565,647 Llenado, issued Jan. 26, 1986; specifically alkylpolyglycosides as discussed in U.S. Pat. Nos. 4,483,780 and 4,483,779; polyhydroxy fatty acid amides as discussed in U.S. Pat. No. 5,332,528; and ether capped poly(oxyalkylated) alcohol surfactants as discussed in U.S. Pat. No. 6,482,994 and WO 01/42408.

Preferred examples of non-ionic surfactants are in particular alkoxylated alcohols and alkoxylated fatty alcohols, di- and multiblock copolymers of ethylene oxide and propylene oxide and reaction products of sorbitan with ethylene oxide or propylene oxide, furthermore alkylphenol ethoxylates, alkyl glycosides, polyhydroxy fatty acid amides (glucamides).

Preferred examples of alkoxylated alcohols and alkoxylated fatty alcohols are, for example, compounds of the general formula (A)

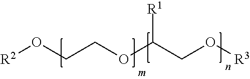

in which the variables are defined as follows:
R¹ is selected from linear C₁-C₁₀-alkyl, preferably ethyl and particularly preferably methyl,
R² is selected from C₈-C₂₂-alkyl, for example n-C₈H₁₇, n-C₁₀H₂₁, n-C₁₂H₂₅, n-C₁₄H₂₉, n-C₁₆H₃₃ or n-C₁₈H₃₇,
R³ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
m and n are in the range from zero to 300, where the sum of n and m is at least one.

Preferably, m is in the range from 1 to 100 and n is in the range from 0 to 30.

Here, compounds of the general formula (A) may be block copolymers or random copolymers, preference being given to block copolymers.

Other preferred examples of alkoxylated alcohols and alkoxylated fatty alcohols are, for example, compounds of the general formula (B)

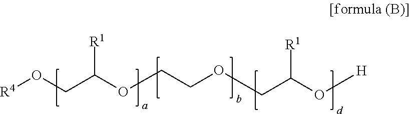

in which the variables are defined as follows:
R¹ is identical or different and selected from linear C₁-C₄-alkyl, preferably identical in each case and ethyl and particularly preferably methyl,
R⁴ is selected from C₆-C₂₀-alkyl, in particular n-C₈H₁₇, n-C₁₀H₂₁, n-C₁₂H₂₅, n-C₁₄H₂₉, n-C₁₆H₃₃, n-C₁₈H₃₇,
a is a number in the range from zero to 6, preferably 1 to 6,
b is a number in the range from zero to 20, preferably 4 to 20,
d is a number in the range from 4 to 25.

Preferably, at least one of a and b is greater than zero.

Here, compounds of the general formula (B) may be block copolymers or random copolymers, preference being given to block copolymers.

Further suitable non-ionic surfactants are selected from di- and multiblock copolymers, composed of ethylene oxide and propylene oxide. Further suitable non-ionic surfactants are selected from ethoxylated or propoxylated sorbitan esters. Alkylphenol ethoxylates or alkyl polyglycosides or polyhydroxy fatty acid amides (glucamides) are likewise suitable. An overview of suitable further non-ionic surfactants can be found in EPA 0 851 023 and in DE-A 198 19 187.

Mixtures of two or more different non-ionic surfactants may of course also be present.

In a preferred embodiment of the present invention, non-ionic surfactants are selected from C_{12/14} and C_{16/18} fatty alkoholalkoxylates, C_{13/15} oxoalkoholalkoxylates, C₁₃-alkoholalkoxylates, and 2-propylheptylalkoholalkoxylates, each of them with 3-15 ethoxy units, preferably 4-10 ethoxy units, or with 1-3 propoxy- and 2-15 ethoxy units.

Non-limiting examples of amphoteric surfactants—which may be employed also in combinations of more than one other surfactant—include: water-soluble amine oxides containing one alkyl moiety of from about 8 to about 18 carbon atoms and 2 moieties selected from the group consisting of alkyl moieties and hydroxyalkyl moieties containing from about 1 to about 3 carbon atoms; and water-soluble sulfoxides containing one alkyl moiety of from about 10 to about 18 carbon atoms and a moiety selected from the group consisting of alkyl moieties and hydroxyalkyl moieties of from about 1 to about 3 carbon atoms. See WO 01/32816, U.S. Pat. Nos. 4,681,704, and 4,133,779. Suitable surfactants include thus so-called amine oxides, such as lauryl dimethyl amine oxide (“lauramine oxide”).

Preferred examples of amphoteric surfactants are amine oxides. Preferred amine oxides are alkyl dimethyl amine oxides or alkyl amido propyl dimethyl amine oxides, more preferably alkyl dimethyl amine oxides and especially coco dimethyl amino oxides. Amine oxides may have a linear or mid-branched alkyl moiety. Typical linear amine oxides include water-soluble amine oxides containing one R¹=C₈₋₁₈ alkyl moiety and two R² and R³ moieties selected from the group consisting of C₁-C₃ alkyl groups and C₁-C₃ hydroxyalkyl groups. Preferably, the amine oxide is characterized by the formula

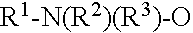

wherein R¹ is a C₈₋₁₈ alkyl and R² and R³ are selected from the group consisting of methyl, ethyl, propyl, isopropyl, 2-hydroxethyl, 2-hydroxypropyl and 3-hydroxypropyl. The linear amine oxide surfactants in particular may include linear C₁₀-C₁₈ alkyl dimethyl amine oxides and linear C₈-C₁₂ alkoxy ethyl dihydroxy ethyl amine oxides. Preferred amine oxides include linear C₁₀, linear C₁₀-C₁₂, and linear C₁₂-C₁₄ alkyl dimethyl amine oxides. As used herein “mid-branched” means that the amine oxide has one alkyl moiety having n1 carbon atoms with one alkyl branch on the alkyl moiety having n2 carbon atoms. The alkyl branch is located on the alpha carbon from the nitrogen on the alkyl moiety. This type of branching for the amine oxide is also known in the art as an internal amine oxide. The total sum of n1 and n2 is from 10 to 24 carbon atoms, preferably from 12 to 20, and more preferably from 10 to 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that (n1-n2) is less than or equal to 5, preferably 4, most preferably from 0 to 4 carbon atoms in at least 50 wt. %, more preferably at least 75 wt. % to 100 wt. % of the mid-branched amine oxides for use herein. The amine oxide further comprises two moieties, independently selected from a C₁-C₃ alkyl, a C₁-C₃ hydroxyalkyl group, or a polyethylene oxide group containing an average of from about 1 to about 3 ethylene oxide groups. Preferably the two moieties are selected from a C₁-C₃ alkyl, more preferably both are selected as a C₁ alkyl.

In a preferred embodiment of the present invention, amphoteric surfactants are selected from C₈-C₁₈ alkyl-dimethyl aminoxides and C₈-C₁₈ alkyl-di(hydroxyethyl)aminoxide.

Cleaning compositions may also contain zwitterionic surfactants—which may be employed also in combinations of more than one other surfactant.

Suitable zwitterionic surfactants include betaines, such as alkyl betaines, alkylamidobetaine, amidazoliniumbetaine, sulfobetaine (INCI Sultaines) as well as the phosphobetaines. Examples of suitable betaines and sulfobetaines are the following (designated in accordance with INCI): Almond amidopropyl of betaines, Apricotamidopropyl betaines, Avocadamidopropyl of betaines, Babassuamidopropyl of betaines, Behenamidopropyl betaines, Behenyl of betaines, Canol amidopropyl betaines, Capryl/Capramidopropyl betaines, Carnitine, Cetyl of betaines, Cocamidoethyl of betaines, Cocamidopropyl betaines, Cocamidopropyl Hydroxysultaine, Coco betaines, Coco Hydroxysultaine, Coco/Oleam idopropyl betaines, Coco Sultaine, Decyl of betaines, Dihydroxyethyl Oleyl Glycinate, Dihydroxyethyl Soy Glycinate, Dihydroxyethyl Stearyl Glycinate, Dihydroxyethyl Tallow Glycinate, Dimethicone Propyl of PG-betaines, Erucamidopropyl Hydroxysultaine, Hydrogenated Tallow of betaines, Isostearamidopropyl betaines, Lauramidopropyl betaines, Lauryl of betaines, Lauryl Hydroxysultaine, Lauryl Sultaine, Milkamidopropyl betaines, Minkamidopropyl of betaines, Myristamidopropyl betaines, Myristyl of betaines, Oleamidopropyl betaines, Oleamidopropyl Hydroxysultaine, Oleyl of betaines, Olivamidopropyl of betaines, Palmamidopropyl betaines, Palmitamidopropyl betaines, Palmitoyl Carnitine, Palm Kernelamidopropyl betaines, Polytetrafluoroethylene Acetoxypropyl of betaines, Ricinoleam idopropyl betaines, Sesamidopropyl betaines, Soyamidopropyl betaines, Stearamidopropyl betaines, Stearyl of betaines, Tallowamidopropyl betaines, Tallowamidopropyl Hydroxysultaine, Tallow of betaines, Tallow Dihydroxyethyl of betaines, Undecylenamidopropyl betaines and Wheat Germamidopropyl betaines.

Preferred betaines are, for example, C₁₂-C₁₈-alkylbetaines and sulfobetaines. The zwitterionic surfactant preferably is a betaine surfactant, more preferably a Cocoamidopropylbetaine surfactant.

Non-limiting examples of cationic surfactants—which may be employed also in combinations of more than one other surfactant—include: the quaternary ammonium surfactants, which can have up to 26 carbon atoms include: alkoxylated quaternary ammonium (AQA) surfactants as discussed in U.S. Pat. No. 6,136,769; dimethyl hydroxyethyl quaternary ammonium as discussed in U.S. Pat. No. 6,004,922; dimethyl hydroxyethyl lauryl ammonium chloride; polyamine cationic surfactants as discussed in WO 98/35002, WO 98/35003, WO 98/35004, WO 98/35005, and WO 98/35006; cationic ester surfactants as discussed in U.S. Pat. Nos. 4,228,042, 4,239,660 4,260,529 and U.S. Pat. No. 6,022,844; and amino surfactants as discussed in U.S. Pat. No. 6,221,825 and WO 00/47708, specifically amido propyldimethyl amine (APA).

Compositions according to the invention may comprise at least one builder. In the context of the present invention, no distinction will be made between builders and such components elsewhere called “co-builders”. Examples of builders are complexing agents, hereinafter also referred to as complexing agents, ion exchange compounds, and precipitating agents. Builders are selected from citrate, phosphates, silicates, carbonates, phosphonates, amino carboxylates and polycarboxylates.

In the context of the present invention, the term citrate includes the mono- and the dialkali metal salts and in particular the mono- and preferably the trisodium salt of citric acid, ammonium or substituted ammonium salts of citric acid as well as citric acid. Citrate can be used as the anhydrous compound or as the hydrate, for example as sodium citrate dihydrate. Quantities of citrate are calculated referring to anhydrous trisodium citrate.

The term phosphate includes sodium metaphosphate, sodium orthophosphate, sodium hydrogenphosphate, sodium pyrophosphate and polyphosphates such as sodium tripolyphosphate. Preferably, however, the composition according to the invention is free from phosphates and polyphosphates, with hydrogenphosphates being subsumed, for example free from trisodium phosphate, pentasodium tripolyphosphate and hexasodium metaphosphate (“phosphate-free”). In connection with phosphates and polyphosphates, “free from” should be understood within the context of the present invention as meaning that the content of phosphate and polyphosphate is in total in the range from 10 ppm to 0.2% by weight of the respective composition, determined by gravimetry.

The term carbonates includes alkali metal carbonates and alkali metal hydrogen carbonates, preferred are the sodium salts. Particularly preferred is Na₂CO₃.

Examples of phosphonates are hydroxyalkanephosphonates and aminoalkanephosphonates. Among the hydroxyalkanephosphonates, the 1-hydroxyethane-1,1-diphosphonate (HEDP) is of particular importance as builder. It is preferably used as sodium salt, the disodium salt being neutral and the tetrasodium salt being alkaline (pH 9). Suitable aminoalkanephosphonates are preferably ethylene diaminetetramethylenephosphonate (EDTMP), diethylenetriaminepentamethylenephosphonate (DTPMP), and also their higher homologues. They are preferably used in the form of the neutrally reacting sodium salts, e.g., as hexasodium salt of EDTMP or as hepta- and octa-sodium salts of DTPMP.

Examples of amino carboxylates and polycarboxylates are nitrilotriacetates, ethylene diamine tetraacetate, diethylene triamine pentaacetate, triethylene tetraamine hexaacetate, propylene diamines tetraacetic acid, ethanol-diglycines, methylglycine diacetate, and glutamine diacetate. The term amino carboxylates and polycarboxylates also include their respective non-substituted or substituted ammonium salts and the alkali metal salts such as the sodium salts, in particular of the respective fully neutralized compound.

Silicates in the context of the present invention include in particular sodium disilicate and sodium metasilicate, alumosilicates such as for example zeolites and sheet silicates, in particular those of the formula α-Na₂Si₂O₅, β-Na₂Si₂O₅, and δ-Na₂Si₂O₅.

Compositions according to the invention may contain one or more builder selected from materials not being mentioned above. Examples of builders are α-hydroxypropionic acid and oxidized starch.

In one embodiment of the present invention, builder is selected from polycarboxylates. The term “polycarboxylates” includes non-polymeric polycarboxylates such as succinic acid, C₂-C₁₆-alkyl disuccinates, C₂-C₁₆-alkenyl disuccinates, ethylene diamine N,N′-disuccinic acid, tartaric acid diacetate, alkali metal malonates, tartaric acid monoacetate, propanetricarboxylic acid, butanetetracarboxylic acid and cyclopentanetetracarboxylic acid.

Oligomeric or polymeric polycarboxylates are for example polyaspartic acid or in particular alkali metal salts of (meth)acrylic acid homopolymers or (meth)acrylic acid copolymers.

Suitable co-monomers are monoethylenically unsaturated dicarboxylic acids such as maleic acid, fumaric acid, maleic anhydride, itaconic acid and citraconic acid. A suitable polymer is in particular polyacrylic acid, which preferably has a weight-average molecular weight Mw in the range from 2000 to 40 000 g/mol, preferably 2000 to 10 000 g/mol, in particular 3000 to 8000 g/mol. Further suitable copolymeric polycarboxylates are in particular those of acrylic acid with methacrylic acid and of acrylic acid or methacrylic acid with maleic acid and/or fumaric acid.

It is also possible to use copolymers of at least one monomer from the group consisting of monoethylenically unsaturated C₃-C₁₀-mono- or C₄-C₁₀-dicarboxylic acids or anhydrides thereof, such as maleic acid, maleic anhydride, acrylic acid, methacrylic acid, fumaric acid, itaconic acid and citraconic acid, with at least one hydrophilically or hydrophobically modified co-monomer as listed below.

Suitable hydrophobic co-monomers are, for example, isobutene, diisobutene, butene, pentene, hexene and styrene, olefins with ten or more carbon atoms or mixtures thereof, such as, for example, 1-decene, 1-dodecene, 1-tetradecene, 1-hexadecene, 1-octadecene, 1-eicosene, 1-docosene, 1-tetracosene and 1-hexacosene, C₂₂-α-olefin, a mixture of C₂₀-C₂₄-α-olefins and polyisobutene having on average 12 to 100 carbon atoms per molecule.

Suitable hydrophilic co-monomers are monomers with sulfonate or phosphonate groups, and also non-ionic monomers with hydroxyl function or alkylene oxide groups. By way of example, mention may be made of: allyl alcohol, isoprenol, methoxypolyethylene glycol (meth)acrylate, methoxypolypropylene glycol (meth)acrylate, methoxypolybutylene glycol (meth)acrylate, methoxypoly(propylene oxide-co-ethylene oxide) (meth)acrylate, ethoxypolyethylene glycol (meth)acrylate, ethoxypolypropylene glycol (meth)acrylate, ethoxypolybutylene glycol (meth)acrylate and ethoxypoly(propylene oxide-co-ethylene oxide) (meth)acrylate. Polyalkylene glycols here can comprise 3 to 50, in particular 5 to 40 and especially 10 to 30 alkylene oxide units per molecule.

Particularly preferred sulfonic-acid-group-containing monomers here are 1-acrylamido-1-propanesulfonic acid, 2-acrylamido-2-propanesulfonic acid, 2-acrylamido-2-methylpropanesulfonic acid, 2-methacrylamido-2-methylpropanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 2-sulfoethyl methacrylate, 3-sulfopropyl methacrylate, sulfomethacrylamide, sulfomethylmethacrylamide, and salts of said acids, such as sodium, potassium or ammonium salts thereof.

Particularly preferred phosphonate-group-containing monomers are vinylphosphonic acid and its salts.

Moreover, amphoteric polymers can also be used as builders.

Compositions according to the invention can comprise, for example, in the range from in total 0.1 to 70% by weight, preferably 10 to 50% by weight, preferably up to 20% by weight, of builder(s), especially in the case of solid formulations. Liquid formulations according to the invention preferably comprise in the range of from 0.1 to 8% by weight of builder.

Formulations according to the invention can comprise one or more alkali carriers. Alkali carriers ensure, for example, a pH of at least 9 if an alkaline pH is desired. Of suitability are, for example, the alkali metal carbonates, the alkali metal hydrogen carbonates, and alkali metal metasilicates mentioned above, and, additionally, alkali metal hydroxides. A preferred alkali metal is in each case potassium, particular preference being given to sodium. In one embodiment of the present invention, a pH>7 is adjusted by using amines, preferably alkanolamines, more preferably triethanolamine.

In one embodiment of the present invention, the composition or laundry formulation according to the invention comprises additionally at least one enzyme.

In one embodiment, the composition according to the present invention additionally comprises at least one enzyme.

Preferably, the at least one enzyme is a detergent enzyme.

In one embodiment, the enzyme is classified as an oxidoreductase (EC 1), a transferase (EC 2), a hydrolase (EC 3), a lyase (EC 4), an isomerase (EC 5), or a ligase (EC 6). The EC-numbering is according to Enzyme Nomenclature, Recommendations (1992) of the Nomenclature Committee of the International Union of Biochemistry and Molecular Biology including its supplements published 1993-1999. Preferably, the enzyme is a hydrolase (EC 3).

In a preferred embodiment, the enzyme is selected from the group consisting of proteases, amylases, lipases, cellulases, mannanases, hemicellulases, phospholipases, esterases, pectinases, lactases, peroxidases, xylanases, cutinases, pectate lyases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, nucleases, DNase, phosphodiesterases, phytases, carbohydrases, galactanases, xanthanases, xyloglucanases, oxidoreductase, perhydrolases, aminopeptidase, asparaginase, carbohydrase, carboxypeptidase, catalase, chitinase, cyclodextrin glycosyltransferase, alpha-galactosidase, beta-galactosidase, glucoamylase, alpha-glucosidase, beta-glucosidase, invertase, ribonuclease, transglutaminase, and dispersins, and combinations of at least two of the foregoing types. More preferably, the enzyme is selected from the group consisting of proteases, amylases, lipases, cellulases, mannanases, xylanases, DNases, dispersins, pectinases, oxidoreductases, and cutinases, and combinations of at least two of the foregoing types. Most preferably, the enzyme is a protease, preferably, a serine protease, more preferably, a subtilisin protease.

Preferably, the protease is a protease with at least 90% sequence identity to SEQ ID NO: 22 of EP1921147B1 and having the amino acid substitution R101E (according to BPN′ numbering). Preferably, the amylase is an amylase with at least 90% sequence identity to SEQ ID NO: 54 of WO2021032881 A1.

The composition of the present invention can comprise one type of enzyme or more than one enzyme of different types, e.g., an amylase and a protease, or more than one enzyme of the same type, e.g., two or more different proteases, or mixtures thereof, e.g., an amylase and two different proteases.

The enzyme(s) can be incorporated into the composition at levels sufficient to provide an effective amount for achieving a beneficial effect, preferably for primary washing effects and/or secondary washing effects, like anti-greying or antipilling effects (e.g., in case of cellulases). Preferably, the enzyme is present in the composition at levels from about 0.00001% to about 5%, preferably from about 0.00001% to about 2%, more preferably from about 0.0001% to about 1%, or even more preferably from about 0.001% to about 0.5% enzyme protein by weight of the composition.

Preferably, the enzyme-containing composition further comprises an enzyme stabilizing system.

Preferably, the enzyme-containing composition described herein comprises from about 0.001% to about 10%, from about 0.005% to about 8%, or from about 0.01% to about 6%, by weight of the composition, of an enzyme stabilizing system. The enzyme stabilizing system can be any stabilizing system which is compatible with the enzyme.

Preferably, the enzyme stabilizing system comprises at least one compound selected from the group consisting of polyols (preferably, 1,3-propanediol, ethylene glycol, glycerol, 1,2-propanediol, or sorbitol), inorganic salts (preferably, CaCl₂, MgCl₂, or NaCl), short chain (preferably, C₁-C₃) carboxylic acids or salts thereof (preferably, formic acid, formate (preferably, sodium formate), acetic acid, acetate, or lactate), borate, boric acid, boronic acids (preferably, 4-formyl phenylboronic acid (4-FPBA)), peptide aldehydes (preferably, Z-VAL-H or Z-GAY-H), peptide acetals, and peptide aldehyde hydrosulfite adducts. Preferably, the enzyme stabilizing system comprises a combination of at least two of the compounds selected from the group consisting of salts, polyols, and short chain carboxylic acids and preferably one or more of the compounds selected from the group consisting of borate, boric acid, boronic acids (preferably, 4-formyl phenylboronic acid (4-FPBA)), peptide aldehydes, peptide acetals, and peptide aldehyde hydrosulfite adducts. In particular, if proteases are present in the composition, protease inhibitors may be added, preferably selected from borate, boric acid, boronic acids (preferably, 4-FPBA), peptide aldehydes (preferably, peptide aldehydes like Z-VAL-H or Z-GAY-H), peptide acetals, and peptide aldehyde hydrosulfite adducts.

Compositions according to the invention may comprise one or more bleaching agent (bleaches). Preferred bleaches are selected from sodium perborate, anhydrous or, for example, as the monohydrate or as the tetrahydrate or so-called dihydrate, sodium percarbonate, anhydrous or, for example, as the monohydrate, and sodium persulfate, where the term “persulfate” in each case includes the salt of the peracid H2SO5 and also the peroxodisulfate.

In this connection, the alkali metal salts can in each case also be alkali metal hydrogen carbonate, alkali metal hydrogen perborate and alkali metal hydrogen persulfate. However, the dialkali metal salts are preferred in each case.

Formulations according to the invention can comprise one or more bleach catalysts. Bleach catalysts can be selected from oxaziridinium-based bleach catalysts, bleach-boosting transition metal salts or transition metal complexes such as, for example, manganese-, iron-, cobalt-, ruthenium- or molybdenum-salen complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Formulations according to the invention can comprise one or more bleach activators, for example tetraacetyl ethylene diamine, tetraacetylmethylene diamine, tetraacetylglycoluril, tetraacetylhexylene diamine, acylated phenolsulfonates such as for example n-nonanoyl- or isononanoyloxybenzene sulfonates, (S)NOBS, LOBS, DOBA, PAP, N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

As precursors of H₂O₂ peroxides come into consideration. i. e. every compound which is capable of yielding hydrogen peroxide in aqueous solutions, for example, the organic and inorganic peroxides known in the literature and available commercially that bleach textile materials at conventional washing temperatures, for example at from 10 to 95 °C.

Preferably, however, inorganic peroxides are used, for example persulfates, perborates, percarbonates and/or persilicates. They are typically used in an amount of 2-80 wt-%, preferably of 4-30 wt-%, based on the weight of the composition.

Typically the compound of formula (1)

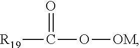

as described in more detail below, is present in the composition in an amount of 0.05-15 wt-%, preferably from 0.1 to 10 wt-%, based on the weight of the total composition.

Examples of suitable inorganic peroxides are sodium perborate tetrahydrate or sodium perborate monohydrate, sodium percarbonate, inorganic peroxyacid compounds, such as for example potassium monopersulphate (MPS). If organic or inorganic peroxyacids are used as the peroxygen compound, the amount thereof will normally be within the range of about 2-80 wt-%, preferably from 4-30 wt-%, based on the weight of the composition.

The organic peroxides are, for example, mono- or poly-peroxides, urea peroxides, a combination of a C₁-C₄alkanol oxidase and C₁-C₄alkanol (Such as methanol oxidase and ethanol as described in WO95/07972), alkylhydroxy peroxides, such as cumene hydroperoxide and t-butyl hydroperoxide.

The peroxides may be in a variety of crystalline forms and have different water contents, and they may also be used together with other inorganic or organic compounds in order to improve their storage stability.

As oxidants, peroxo acids can also be used. One example are organic mono peracids of formula (1)

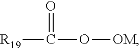

wherein
M signifies hydrogen or a cation,
R₁₉ signifies unsubstituted C₁-C₁₈alkyl; substituted C₁-C₁₈alkyl; unsubstituted aryl; substituted aryl; —(C₁-C₆alkylene)-aryl, wherein the alkylene and/or the alkyl group may be substituted; and phthalimidoC₁-C₈alkylene, wherein the phthalimido and/or the alkylene group may be substituted.

Preferred mono organic peroxy acids and their salts are those of formula

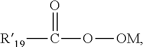

wherein
M signifies hydrogen or an alkali metal, and
R′₁₉ signifies unsubstituted C₁-C₄alkyl; phenyl; —C₁-C₂alkylene-phenyl or phthalimidoC₁-C₈alkylene.

Especially preferred is CH₃COOOH and its alkali salts.

Especially preferred is also e-phthalimido peroxy hexanoic acid and its alkali salts (PAP).

Also suitable are diperoxyacids, for example, 1,12-diperoxydodecanedioic acid (DPDA), 1,9-diperoxyazelaic acid, diperoxybrassilic acid, diperoxysebasic acid, diperoxyisophthalic acid, 2-decyldiperoxybutane-1,4-diotic acid and 4,4′-sulphonylbisperoxybenzoic acid.

In some cases the use of an additional bleach activator may be of advantage.

The term bleach activator is frequently used as a synonym for peroxyacid bleach precursor. All the above mentioned peroxy compounds may be utilized alone or in conjunction with a peroxyacid bleach precursor.

Such precursors are the corresponding carboxyacid or the corresponding carboxyanhydride or the corresponding carbonylchlorid, or amides, or esters, which can form the peroxy acids on perhydrolysis. Such reactions are commonly known.

Peroxyacid bleach precursors are known and amply described in literature, such as in the British Patents 836988; 864,798; 907,356; 1,003,310 and 1,519,351; German Patent 3,337,921; EP-A-0185522; EP-A-0174132; EP-A-0120591; and U.S. Pat. Nos. 1,246,339; 3,332,882; 4,128,494; 4,412,934 and 4,675,393.

Suitable bleach activators include the bleach activators, that carry O- and/or N-acyl groups and/or unsubstituted or substituted benzoyl groups. Preference is given to polyacylated alkylenediamines, especially tetraacetylethylenediamine (TAED); acylated glycolurils, especially tetraacetyl glycol urea (TAGU), N,N-diacetyl-N,N-dimethylurea (DDU); sodium-4-benzoyloxy benzene sulphonate (SBOBS); sodium-1-methyl-2-benzoyloxy benzene-4-sulphonate; sodium-4-methyl-3-benzoloxy benzoate; trimethyl ammonium toluyloxy-benzene sulphonate; acylated triazine derivatives, especially 1,5-diacetyl-2,4-dioxohexahydro-1,3,5-triazine (DADHT); compounds of formula (10):

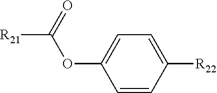

wherein R₂₂ is a sulfonate group, a carboxylic acid group or a carboxylate group, and wherein R₂₁ is linear or branched (C₇-C₁₅)alkyl, especially activators known under the names SNOBS, SLOBS and DOBA; acylated polyhydric alcohols, especially triacetin, ethylene glycol diacetate and 2,5-diacetoxy-2,5-dihydrofuran; and also acetylated sorbitol and mannitol and acylated sugar derivatives, especially pentaacetylglucose (PAG), sucrose polyacetate (SUPA), pentaacetylfructose, tetraacetylxylose and octaacetyllactose as well as acetylated, optionally N-alkylated glucamine and gluconolactone. It is also possible to use the combinations of conventional bleach activators known from German Patent Application DE-A-44 43 177. Nitrile compounds that form perimine acids with peroxides also come into consideration as bleach activators.

Another useful class of peroxyacid bleach precursors is that of the cationic i.e. quaternary ammonium substituted peroxyacid precursors as disclosed in U.S. Pat. Nos. 4,751,015 and 4,397,757, in EP-A0284292 and EP-A-331,229. Examples of peroxyacid bleach precursors of this class are: 2-(N,N,N-trimethyl ammonium) ethyl sodium-4-sulphonphenyl carbonate chloride—(SPCC), N-octyl,N,N-dimehyl-N10-carbophenoxy decyl ammonium chloride—(ODC), 3-(N,N,N-trimethyl ammonium) propyl sodium-4-sulphophenyl carboxylate and N,N,N-trimethyl ammonium toluyloxy benzene sulphonate.

It is also possible to use additional bleach catalysts, which are commonly known, for example transition metal complexes as disclosed in EP 1194514, EP 1383857 or WO04/007657.

Formulations according to the invention can comprise one or more corrosion inhibitors. In the present case, this is to be understood as including those compounds which inhibit the corrosion of metal. Examples of suitable corrosion inhibitors are triazoles, in particular benzotriazoles, bisbenzotriazoles, aminotriazoles, alkylaminotriazoles, also phenol derivatives such as, for example, hydroquinone, pyrocatechol, hydroxyhydroquinone, gallic acid, phloroglucinol or pyrogallol.

In one embodiment of the present invention, formulations according to the invention comprise in total in the range from 0.1 to 1.5% by weight of corrosion inhibitor.

Formulations according to the invention may also comprise further cleaning polymers and/or soil release polymers.

The additional cleaning polymers may include, without limitation, “multifunctional alkoxylated polyethylene imines” (for example BASF's Sokalan® HP20), “multifunctional alkoxylated diamines” (for example BASF's Sokalan® HP96), BASF's Sokalan® SR400 A and also terephthalic acid-based polyesters like Clariant's TexCare®, such as TexCare® SRN 170, TexCare® SRN 172, TexCare® SRN 260, TexCare® SRN 260 SG Terra and TexCare® SRA 300 as well as distinct combinations of all of the before mentioned polymers.

Suitable multifunctional alkoxylated polyethylene imines are typically ethoxylated polyethylene imines with a weight-average molecular weight Mw in the range from 3000 to 250000, preferably 5000 to 200000, more preferably 8000 to 100000, more preferably 8000 to 50000, more preferably 10000 to 30000, and most preferably 10000 to 20000 g/mol. Suitable multifunctional alkoxylated polyethylene imines have 80 wt. % to 99 wt. %, preferably 85 wt. % to 99 wt. %, more preferably 90 wt. % to 98 wt. %, most preferably 93 wt. % to 97 wt. % or 94 wt. % to 96 wt. % ethylene oxide side chains, based on the total weight of the materials. Ethoxylated polyethylene imines are typically based on a polyethylene imine core and a polyethylene oxide shell. Suitable polyethylene imine core molecules are polyethylene imines with a weight-average molecular weight Mw in the range of 500 to 5000 g/mol. Preferably employed is a molecular weight from 500 to 1000 g/mol, even more preferred is a Mw of 600 to 800 g/mol. The ethoxylated polymer then has on average 5 to 50, preferably 10 to 35 and even more preferably 20 to 35 ethylene oxide (EO) units per NH-functional group.

Suitable multifunctional alkoxylated diamines are typically ethoxylated C₂ to C₁₂ alkylene diamines, preferably hexamethylene diamine, which are further quaternized and optionally sulfated. Typical multifunctional alkoxylated diamines have a weight-average molecular weight Mw in the range from 2000 to 10000, more preferably 3000 to 8000, and most preferably 4000 to 6000 g/mol. In a preferred embodiment of the invention, ethoxylated hexamethylene diamine, furthermore quaternized and sulfated, may be employed, which contains on average 10 to 50, preferably 15 to 40 and even more preferably 20 to 30 ethylene oxide (EO) groups per NH-functional group, and which preferably bears two cationic ammonium groups and two anionic sulfate groups.

It is noted that the cleaning compositions of the invention can also comprise at least one propoxylated polyol of the invention and in addition at least one propoxylated polyol that does not form part of the claims, such as propoxylated polyol derived from polyols having three —OH groups (such as propoxylated glycerol) or six —OH groups (such as propoxylated sorbitol).

In a preferred embodiment of the present invention, the cleaning compositions may contain at least one multifunctional alkoxylated polyethylene imine and/or at least one multifunctional alkoxylated diamine to improve the cleaning performance, such as preferably improve the stain removal ability, especially the primary detergency of particulate stains on polyester fabrics of laundry detergents. The multifunctional polyethylene imines or multifunctional diamines or mixtures thereof according to the descriptions above may be added to the laundry detergents and cleaning compositions in amounts of generally from 0.05 to 15 wt. %, preferably from 0.1 to 10 wt. % and more preferably from 0.25 to 5 wt. % and even as low as up to 2 wt. %, based on the particular overall composition, including other components and water and/or solvents.

In another preferred embodiment of the present invention, the cleaning compositions may contain at least one terephthalic acid-based polyester, employed as soil release polymer, to improve the whiteness of the fabrics after the wash, especially the whiteness of polyester fabrics.

Thus, one aspect of the present invention is a laundry detergent composition, in particular a liquid laundry detergent, comprising (i) at least one inventive compound and (ii) at least one compound selected from multifunctional alkoxylated polyethylene imines, multifunctional alkoxylated diamines and terephthalic acid-based polyesters, and mixtures thereof.

In one embodiment of the present invention, the ratio of the at least one inventive compound and (ii) the at least one compound selected from multifunctional polyethylene imines and multifunctional diamines and mixtures thereof, is from 10:1 to 1:10, preferably from 5:1 to 1:5 and more preferably from 3:1 to 1:3.

Laundry formulations comprising the inventive compound may also comprise at least one antimicrobial agent (also often named preservatives).

The composition may contain one or more antimicrobial agents and/or preservatives as listed in patent WO2021/115912 A1 on pages 35 to 39.

Especially of interest are the following antimicrobial agents and/or preservatives:

4,4′-dichloro 2-hydroxydiphenyl ether (CAS-No. 3380-30-1), further names: 5-chloro-2-(4-chlorophenoxy) phenol, Diclosan, DCPP, which is commercially avail-able as a solution of 30 wt % of 4,4′-dichloro 2-hydroxydiphenyl ether in 1,2 propyl-eneglycol under the trade name Tinosan® HP 100 (BASF); 2-Phenoxyethanol (CAS-no. 122-99-6, further names: Phenoxyethanol, Methylphenylglycol, Phenoxetol, ethylene glycol phenyl ether, Ethylene glycol monophenyl ether, Protectol® PE); 2-bromo-2-nitropropane-1,3-diol (CAS-No. 52-51-7, further names: 2-bromo-2-nitro-1,3-propanediol, Bronopol®, Protectol® BN, Myacide AS); Glutaraldehyde (CAS-No. 111-30-8, further names: 1-5-pentandial, pentane-1,5-dial, glutaral, glutardialdehyde, Protectol® GA, Protectol® GA 50, Myacide® GA); Glyoxal (CAS No. 107-22-2; further names: ethandial, oxylaldehyde, 1,2-ethandial, Protectol® GL); 2-butyl-benzo[d]isothiazol-3-one (BBIT, CAS No. 4299-07-4); 2-methyl-2H-isothiazol-3-one (MIT, CAS No 2682-20-4); 2-octyl-2H-isothiazol-3-one (OIT, CAS No. 26530-20-1); 5-Chloro-2-methyl-2H-isothiazol-3-one (CIT, CMIT, CAS No. 26172-55-4); Mixture of 5-chloro-2-methyl-2H-isothiazol-3-one (CMIT, EINECS 247-500-7) and 2-methyl-2H-isothiazol-3-one (MIT, EINECS 220-239-6) (Mixture of CMIT/MIT, CAS No. 55965-84-9); 1,2-benzisothiazol-3(2H)-one (BIT, CAS No. 2634-33-5); Hexa-2,4-dienoic acid (Sorbic acid, CAS No. 110-44-1) and its salts, e.g. calcium sorbate, sodium sorbate, potassium (E,E)-hexa-2,4-dienoate (Potassium Sorbate, CAS No. 24634-61-5); Lactic acid and its salts; L-(+)-lactic acid (CAS No. 79-33-4); Benzoic acid and its sodium salt (CAS No 65-85-0, CAS No. 532-32-1) and salts of benzoic acid e.g. ammonium benzoate, calcium benzoate, magnesium benzoate, MEA-benzoate, potassium benzoate; Salicylic acid and its salts, e.g. calcium salicylate, magnesium salicylate, MEA salicylate, sodium salicylate, potassium salicylate, TEA salicylate; Benzalkonium chloride, bromide and saccharinate, e.g. benzalkonium chloride, benzalkonium bromide, benzalkonium saccharinate (CAS Nos 8001-54-5, 63449-41-2, 91080-29-4, 68989-01-5, 68424-85-1, 68391-01-5, 61789-y71-7, 85409-22-9); Didecyldimethylammonium chloride (DDAC, CAS No. 68424-95-3 and CAS No. 7173-51-5); N-(3-aminopropyl)-N-dodecylpropane-1,3-diamine (Diamine, CAS No. 2372-82-9); Peracetic acid (CAS No. 79-21-0); Hydrogen peroxide (CAS No. 7722-84-1).

The antimicrobial agent is added to the composition in a concentration of 0.001 to 10% relative to the total weight of the composition.

Preferably, the composition contains 2-Phenoxyethanol in a concentration of 0.1 to 2% or 4,4′-dichloro 2-hydroxydiphenyl ether (DCPP) in a concentration of 0.005 to 0.6%.

The invention thus further encompasses a method of preserving an aqueous composition according to the invention against microbial contamination or growth, which method comprises addition of 2-Phenoxyethanol. The invention thus further encompasses a method of providing an antimicrobial effect on textiles after treatment with a solid laundry detergent e.g., powders, granulates, capsules, tablets, bars etc.), a liquid laundry detergent, a softener or an after rinse containing 4,4′-dichloro 2-hydroxydiphenyl ether (DCPP).

In a further embodiment, this invention also encompasses a composition comprising an inventive compound as descried herein before, further comprises an antimicrobial agent as disclosed hereinafter, preferably selected from the group consisting of 2-phenoxyethanol, more preferably comprising said antimicrobial agent in an amount ranging from 2 ppm to 5% by weight of the composition; even more preferably comprising 0.1 to 2% of phenoxyethanol.

In a further embodiment, this invention also encompasses a method of preserving an aqueous composition against microbial contamination or growth, such composition comprising an inventive compound as described herein before, such composition being preferably a detergent composition, such method comprising adding at least one antimicrobial agent selected from the disclosed antimicrobial agents as disclosed hereinafter, such antimicrobial agent preferably being 2-phenoxyethanol.

In a further embodiment, this invention also encompasses a composition, preferably a cleaning composition, more preferably a liquid laundry detergent composition or a liquid hand dish composition, even more preferably a liquid laundry detergent composition, or a liquid softener composition for use in laundry, such composition comprising an inventive compound as described herein before, such composition further comprising 4,4′-dichoro 2-hydroxydiphenylether in a concentration from 0.001 to 3%, preferably 0.002 to 1%, more preferably 0.01 to 0.6%, each by weight of the composition.

In a further embodiment, this invention also encompasses a method of laundering fabric or of cleaning hard surfaces, which method comprises treating a fabric or a hard surface with a cleaning composition, more preferably a liquid laundry detergent composition or a liquid hand dish composition, even more preferably a liquid laundry detergent composition, or a liquid softener composition for use in laundry, such composition comprising an inventive compound as described herein before, such composition further comprising 4,4′-dichoro 2-hydroxydiphenylether.

The term “dye fixation agent”, as used herein, relates to compounds that attenuate or even terminate dye bleeding of colored fabrics during the washing process. Dye fixation agents include, but are not limited to cationic dye fixation agents, crosslinking fixation agents and formaldehyde-based fixation agents. The skilled person is well-aware of these compounds and may purchase commercially available products from BASF SE, Huntsman, Archroma, Fineotex, Biotex Malaysia or Dystar. Exemplified, but not limiting dye fixation agents are Basilen Fixing Agent F—RP, Albafix ECO, Finofix NF, poly DADMAC, Polyamine (DCDA-DETA, Epichloro-DMA, Epichloro-DETA, etc.).

Formulations according to the invention may also comprise water and/or additional organic solvents, e.g., ethanol or propylene glycol.

Further optional ingredients may be but are not limited to viscosity modifiers, cationic surfactants, foam boosting or foam reducing agents, perfumes, dyes, optical brighteners, and dye transfer inhibiting agents.

### (b) General Cleaning Compositions and Formulations

The liquid formulations disclosed in this chapter may comprise 0 to 2% 2-phenoxyethanol, preferably about 1%, in addition to all other mentioned ingredients.

The above and below disclosed liquid formulations may comprise 0-0.2% 4,4′-dichoro 2-hydroxydiphenylether, preferably about 0.15%, in addition to all other mentioned ingredients.

The bleach-free solid laundry compositions may comprise 0-0.2% 4,4′-dichoro 2-hydroxydiphenylether, preferably about 0.15%, in addition to all other mentioned ingredients.

The formulations disclosed in this chapter may—in addition to all other mentioned ingredients—comprise one or more enzymes selected from those disclosed herein above, more preferably a protease and/or an amylase, wherein even more preferably the protease is a protease with at least 90% sequence identity to SEQ ID NO: 22 of EP1921147B1 and having the amino acid substitution R101E (according to BPN′ numbering) and wherein the amylase is an amylase with at least 90% sequence identity to SEQ ID NO: 54 of WO2021032881 A1, such enzyme(s) preferably being present in the formulations at levels from about 0.00001% to about 5%, preferably from about 0.00001% to about 2%, more preferably from about 0.0001% to about 1%, or even more preferably from about 0.001% to about 0.5% enzyme protein by weight of the composition.

The following compositions shown below including those in the tables disclose general cleaning compositions of certain types, which correspond to typical compositions correlating with typical washing conditions as typically employed in various regions and countries of the world. The at least one inventive compound may be added to such formulation(s) in suitable amounts as outlined herein.

When the shown composition does not comprise an inventive compound, such composition is a comparative composition. When it comprises an inventive compound, especially in the amounts that are described herein as preferred, more preferred etc. ranges, such compositions are considered to fall within the scope of the present invention.

In a preferred embodiment the at least one propoxylated polyol (as defined in any of the embodiments herein, especially the Embodiments 1 to 11; propoxylated polyols in this section also named “inventive compound”) is used in a laundry detergent.

Liquid laundry detergents according to the present invention are composed of:
0.05-20% of at least one inventive compound
1-50% of surfactants
0.1-40% of builders, cobuilders and/or chelating agents
0.1-50% other adjuncts
water to add up 100%.

Preferred liquid laundry detergents according to the present invention are composed of:
0.2-6% of at least one inventive compound
5-40% of anionic surfactants selected from C₁₀-C₁₅-LAS and C₁₀-C₁₈ alkyl ether sulfates containing 1-5 ethoxy-units
1.5-10% of nonionic surfactants selected from C₁₀-C₁₈-alkyl ethoxylates containing 3-10 ethoxy-units
2-20% of soluble organic builders/cobuilders selected from C₁₀-C₁₈ fatty acids, di- and tricarboxylic acids, hydroxy-di- and hydroxytricaboxylic acids and polycarboxylic acids
0.05-5% of an enzyme system containing at least one enzyme suitable for detergent use and preferably also an enzyme stabilizing system
0.5-20% of mono- or diols selected from ethanol, isopropanol, ethylene glycol, or propylene glycol
0.1-20% other adjuncts
water to add up to 100%.

Solid laundry detergents (like e.g., powders, granules or tablets) according to the present invention are composed of:
0.05-20% of at least one inventive compound
1-50% of surfactants
0.1-80% of builders, cobuilders and/or chelating agents
0-50% fillers
0-40% bleach actives
0.1-30% other adjuncts and/or water
wherein the sum of the ingredients adds up 100%.

Preferred solid laundry detergents according to the present invention are composed of:
0.2-6% of at least one inventive compound
5-30% of anionic surfactants selected from C₁₀-C₁₅-LAS, C₁₀-C₁₈ alkyl sulfates and C₁₀-C₁₈ alkyl ether sulfates containing 1-5 ethoxy-units
1.5-7.5% of non-ionic surfactants selected from C₁₀-C₁₈-alkyl ethoxylates containing 3-10 ethoxy-units
5-50% of inorganic builders selected from sodium carbonate, sodium bicarbonate, zeolites, soluble silicates, sodium sulfate
0.5-15% of cobuilders selected from C₁₀-C₁₈ fatty acids, di- and tricarboxylic acids, hydroxydi- and hydroxytricarboxylic acids and polycarboxylic acids
0.1-5% of an enzyme system containing at least one enzyme suitable for detergent use and preferably also an enzyme stabilizing system
0.1-20% other adjuncts
water to add up to 100%.

In a preferred embodiment the polymer according to the present invention is used in a manual dish wash detergent.

Liquid manual dish wash detergents according to the present invention are composed of:
0.05-10% of at least one inventive compound
1-50% of surfactants
0.1-50% of other adjuncts
water to add up 100%.

Preferred liquid manual dish wash detergents according to the present invention are composed of:
0.2-5% of at least one inventive compound
5-40% of anionic surfactants selected from C₁₀-C₁₅-LAS, C₁₀-C₁₈ alkyl ether sulfates containing 1-5 ethoxy-units, and C₁₀-C₁₈ alkyl sulfate
0-10% of Cocamidopropylbetaine
0-10% of Lauramine oxide
0-2% of a non-ionic surfactant, preferably a C₁₀-Guerbet alcohol alkoxylate
0-5% of an enzyme, preferably Amylase, and preferably also an enzyme stabilizing system
0.5-20% of mono- or diols selected from ethanol, isopropanol, ethylene glycol, or propylene glyclol
0.1-20% other adjuncts
water to add up to 100%

As the polyalkylene imine or polyamine polymers of the invention are biodegradable, and especially the cleaning formulations typically have a pH of about 7 or higher, and additionally often contain also enzymes—which are included into such cleaning formulations to degrade biodegradable stuff such as grease, proteins, polysaccharides etc. which are present in the stains and dirt which shall be removed by the cleaning compositions—some consideration is needed to be taken to formulate those bio-degradable polymers of the invention. Such formulations suitable are in principle known, and include the formulation in solids—where the enzymes and the polymers can be separated by coatings or adding them in separate particles which are mixed—and liquids and semi-liquids, where the polymers and the enzymes can be separated by formulating them in different compartments, such as different compartments of multi-chamber-pouches or bottles having different chambers, from which the liquids are poured out at the same time in a predefined amount to assure the application of the right amount per individual point of use of each component from each chamber. Such multi-compartment-pouches and bottles etc. are known to a person of skill as well.

The following table shows general cleaning compositions of certain types, which correspond to typical compositions correlating with typical washing conditions as typically employed in various regions and countries of the world. The at least one inventive compound may be added to such formulation(s) in suitable amounts as outlined herein.

TABLE 1
General formula for laundry detergent compositions
according to the invention:

| | Ranges of Ingredient in |
|---|---|
| Ingredient | Liquid frame formulations |
| Linear alkyl benzene sulphonic acid | 0 to 30% |
| Coco fatty acid | 1 to 12% |
| Fatty alcohol ether sulphate | 0 to 25% |
| NaOH or mono- or triethanolamine | Up to pH 7.5 to 9.0 |
| Alcohol ethoxylate | 3 to 10% |
| 1,2-Propylene glycol | 1 to 10% |
| Ethanol | 0 to 4% |
| Sodium citrate | 0 to 8% |
| Inventive compound(s) | 0.1 to 5% |
| water | Up to 100% |

TABLE 2
Liquid laundry frame formulations according to the invention:

| active | | | | | | |
|---|---|---|---|---|---|---|
| (numbers: % active) | F1 | F2 | F3 | F4 | F5 | F6 |
| alcohol ethoxylate 7EO | 5.40 | 10.80 | 12.40 | 7.30 | 1.60 | 7.60 |
| Coco fatty acid K12-18 | 2.40 | 3.10 | 3.20 | 3.20 | 3.50 | 6.40 |
| Fatty alcohol ether sulphate | 5.40 | 8.80 | 7.10 | 7.10 | 5.40 | 14.00 |
| Linear alkyl benzene sulphonic | 5.50 | 0.00 | 14.50 | 15.50 | 10.70 | 0.00 |
| acid | | | | | | |
| 1,2 Propane diol | 6.00 | 3.50 | 8.70 | 8.70 | 1.10 | 7.80 |
| Triethanolamine | | | | | | |
| Monoethanolamine | | | 4.00 | 4.30 | 0.30 | |
| NaOH | 2.20 | 1.10 | | | | 1.00 |
| Glycerol | | 0.80 | 3.00 | 2.80 | | |
| Ethanol | 2.00 | | | | 0.38 | 0.39 |
| Na citrate | 3.00 | 2.80 | 3.40 | 2.10 | 7.40 | 5.40 |
| Inventive compound(s) (total)* | 0.01-5 | 0.01-5 | 0.01-5 | 0.01-5 | 0.01-5 | 0.01-5 |
| Protease | 0-1 | 0-1 | 0-1 | 0-1 | 0-1 | 0-1 |
| Amylase | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 |
| water | to 100 | to 100 | to 100 | to 100 | to 100 | to 100 |

| active | | | | | | | | |
|---|---|---|---|---|---|---|---|---|
| (numbers: % active) | F7 | F8 | F9 | F10 | F11 | F12 | F13 | F14 |
| alcohol ethoxylate 7EO | 3.80 | 0.30 | 13.30 | 8.00 | 5.70 | 20.00 | 9.20 | 29.00 |
| Coco fatty acid K12-18 | 2.80 | 3.00 | 1.70 | 1.80 | 2.50 | 5.00 | 8.60 | 10.40 |
| Fatty alcohol ether sulphate | 2.80 | 4.50 | 3.90 | 4.10 | | 10.00 | 22.20 | |
| Linear alkyl benzene | 6.30 | 5.43 | 11.45 | 5.90 | 10.10 | 10.00 | 28.00 | 27.00 |
| sulphonic acid | | | | | | | | |
| 1,2 Propane diol | 0.50 | | 2.50 | 0.40 | 6.00 | 10.00 | 7.00 | 7.00 |
| Triethanolamine | | | | 8.10 | | | | |
| Monoethanolamine | 0.40 | 1.80 | | | | | 8.00 | 7.00 |
| NaOH | | | 2.20 | | 3.30 | 1.50 | | |
| Glycerol | | 0.60 | 0.20 | 1.90 | | | 7.00 | 10.00 |
| Ethanol | | | 1.84 | | | | | |
| Na citrate | 4.60 | 3.30 | 3.30 | 1.40 | | 1.50 | | |
| Inventive compound(s) | 0.01-5 | 0.01-5 | 0.01-5 | 0.01-5 | 0.01-5 | 0.01-5 | 0.01-5 | 0.01-5 |
| (total)* | | | | | | | | |
| Protease | 0-1 | 0-1 | 0-1 | 0-1 | 0-1 | 0-3 | 0-3 | 0-3 |
| Amylase | 0-0.5 | 0-0.5 | 0-0.5 | 0-0.5 | 0-0.5 | 0-0.5 | 0-0.5 | 0-0.5 |
| Cellulase | 0-0.3 | 0-0.3 | 0-0.3 | 0-0.3 | 0-0.3 | 0-0.3 | 0-0.3 | 0-0.3 |
| Lipase | 0-0.2 | 0-0.2 | 0-0.2 | 0-0.2 | 0-0.2 | 0-0.2 | 0-0.2 | 0-0.2 |
| Mannanase | 0-0.2 | 0-0.2 | 0-0.2 | 0-0.2 | 0-0.2 | 0-0.2 | 0-0.2 | 0-0.2 |
| Pectat Lyase | 0-0.3 | 0-0.3 | 0-0.3 | 0-0.3 | 0-0.3 | 0-0.3 | 0-0.3 | 0-0.3 |
| water | to 100 | to 100 | to 100 | to 100 | to 100 | to 100 | to 100 | to 100 |

*Without inventive compound the formulations are comparative examples.
*Without inventive compound the formulations are comparative examples.

TABLE 3
Laundry powder frame formulations according to the invention:

| | Bleach free Powder | | | | | |
|---|---|---|---|---|---|---|
| Alcohol ethoxylate 7EO | 0.6 | 0 | 1 | 0 | 0 | 5.2 |
| Coco fatty acid K12-18 | 1.2 | 0 | 0 | 0 | 0 | 0 |
| Fatty alcohol ether sulphate | 1.5 | 0 | 0 | 0 | 0 | 6 |
| Linear alkyl benzene sulphonic | 12.1 | 11.2 | 13.6 | 21.9 | 18.7 | 12.7 |
| acid | | | | | | |
| Bleach activator | 0 | 0 | 0 | 0 | 0 | 0 |
| Percarbonate | 0 | 0 | 0 | 0 | 0 | 0 |
| AcetateNa | 0 | 0 | 0 | 0.1 | 0 | 0.1 |
| CitrateNa | 0 | 0 | 0 | 0 | 0 | 14 |
| Na Silicate | 27.9 | 5.8 | 6.6 | 2 | 15 | 20.3 |
| Na Carbonate | 17.2 | 35 | 37.3 | 30.1 | 37 | 1 |
| Na Phosphate | 0 | 0 | 0 | 14 | 0.3 | 0 |
| Na Hydrogencarbonate | 0.7 | 0.9 | 0.5 | 2.7 | 0.4 | 10.5 |
| Zeolite4A | 4.2 | 0.1 | 5.1 | 10.2 | 1.8 | 11.6 |
| HEDP | 0 | 0 | 0 | 0 | 0 | 0.13 |
| MGDA | 0 | 1.1 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 30.8 | 1.3 | 33 | 11 | 22 | 3 |
| Na Chloride | 0.2 | 43 | 0.1 | 0 | 0.1 | 0.1 |
| optical brightener | 0.02 | 0 | | 0.1 | 0.06 | |
| Inventive compound(s) (total) | 1 | 1 | 0.2 | 2 | 0.5 | 3 |
| | Bleach containing Powder | | | | | |
| Alcohol ethoxylate 7EO | 1.2 | 5 | 4 | 0.5 | 0.5 | 0 |
| Coco fatty acid K12-18 | 0 | 0 | 0 | 0.3 | 0 | 0.6 |
| Fatty alcohol ether sulphate | 0 | 3.9 | 4.4 | 1.6 | 0 | 0 |
| Linear alkyl benzene sulphonic | 7.6 | 12.1 | 11.5 | 12.2 | 6.5 | 10.4 |
| acid | | | | | | |
| Bleach activator | 0.2 | 9.5 | 9.5 | 0.5 | 0.8 | 2.2 |
| Percarbonate | 3.6 | 19.4 | 16.6 | 2.2 | 11.5 | 5.8 |
| AcetateNa | 0 | 6.7 | 7.1 | 0.3 | 1 | 0.7 |
| CitrateNa | 0 | 1.6 | 8.2 | 0.3 | 0.9 | 1.7 |
| Na Silicate | 3.6 | 11.3 | 16.4 | 10.2 | 9.1 | 16.5 |
| Na Carbonate | 21.6 | 8.7 | 1.4 | 8 | 22.9 | 14.8 |
| Na Phosphate | 0 | 0 | 0 | 0 | 0 | 0 |
| Na Hydrogencarbonate | 0.2 | 2.8 | 1.6 | 0.8 | 0.5 | 0.5 |
| Zeolite4A | 1.6 | 1.4 | 2.4 | 1.6 | 1.8 | 2.3 |
| HEDP | 0 | 0.27 | 0.16 | 0 | 0 | 0.17 |
| MGDA | 0 | 0 | 0 | 0 | 0 | 0 |
| Cellulase | 0-0.5 | 0-0.5 | 0-0.5 | 0-0.5 | 0-0.5 | 0-0.5 |
| Lipase | 0-0.4 | 0-0.4 | 0-0.4 | 0-0.4 | 0-0.4 | 0-0.4 |
| Mannanase | 0-0.4 | 0-0.4 | 0-0.4 | 0-0.4 | 0-0.4 | 0-0.4 |
| Protease | 0-1.5 | 0-1.5 | 0-1.5 | 0-1.5 | 0-1.5 | 0-1.5 |
| Amylase | 0-0.5 | 0-0.5 | 0-0.5 | 0-0.5 | 0-0.5 | 0-0.5 |
| Na Sulfate | 51 | 4 | 6 | 57 | 38 | 37 |
| Na Chloride | 1 | 1 | 0.5 | 1.2 | 0.2 | 1 |
| optical brightener | | 0.29 | 0.1 | 0.23 | 0.13 | 0.19 |
| Inventive compound(s) (total) | 2.2 | 9.2 | 2.2 | 0.7 | 1 | 0.4 |

TABLE 4
Liquid manual dish wash frame formulations according to the invention:

| Ingredients | MDW.1 | MDW.2 | MDW.3 | MDW.4 | MDW.5 | MDW.6 | MDW.7 | MDW.8 |
|---|---|---|---|---|---|---|---|---|
| Linear C₁₂-C₁₄- | 8 | 0 | 6 | 0 | 6 | 0 | 6 | 0 |
| alkylbenzenesulfonic | | | | | | | | |
| acid | | | | | | | | |
| C₁₂-C₁₄-fatty alcohol × 2 EO sulfate | 8 | 16 | 6 | 12 | 6 | 12 | 6 | 12 |
| Cocamidopropyl | 0 | 0 | 4 | 4 | 0 | 0 | 2 | 2 |
| betaine | | | | | | | | |
| Lauramine oxide | 0 | 0 | 0 | 0 | 4 | 4 | 2 | 2 |
| 2-Propylheptanol × 4 | 0.5 | 0.5 | 0.5 | 0.5 | 0.5 | 0.5 | 0.5 | 0.5 |
| EO | | | | | | | | |
| Inventive | 1 | 1 | 1 | 1 | 1 | 1 | 1 | 1 |
| compound(s) (total) | | | | | | | | |
| Ethanol | 2 | 2 | 2 | 2 | 2 | 2 | 2 | 2 |
| 2-Phenoxyethanol | 1 | 1 | 1 | 1 | 1 | 1 | 1 | 1 |
| (preservative) | | | | | | | | |
| Sodium chloride | 1 | 1 | 1 | 1 | 1 | 1 | 1 | 1 |
| Demin. water | add | add | add | add | add | add | add | add |
| | 100 | 100 | 100 | 100 | 100 | 100 | 100 | 100 |
| Sodium hydroxide | add | add | add | add | add | add | add | add |
| | pH 8 | pH 8 | pH 8 | pH 8 | pH 8 | pH 8 | pH 8 | pH 8 |

The following examples shall further illustrate the present invention without restricting the scope of the invention.

The specific embodiments as described throughout this disclosure are encompassed by the present invention as part of this invention; the various further options being disclosed in this present specification as “optional”, “preferred”, “more preferred”, “even more preferred” or “most preferred” (or “preferably” etc.) options of a specific embodiment may be individually and independently (unless such independent selection is not possible by virtue of the nature of that feature or if such independent selection is explicitly excluded) selected and then combined within any of the other embodiments (where other such options and preferences can be also selected individually and independently unless such independent selection is not possible by virtue of the nature of that feature or if such independent selection is explicitly excluded), with each and any and all such possible combinations being included as part of this invention as individual embodiments.

### EXAMPLES

### Method of Testing Polymer Biodegradation

Biodegradation in wastewater was tested in triplicate using the OECD 301F manometric respirometry method. OECD 301F is an aerobic test that measures biodegradation of a sample by measuring the consumption of oxygen. To a measured volume of medium, 100 mg/L test substance, which is the nominal sole source of carbon is added along with the inoculum (30 mg/L, aerated sludge taken from Mannheim wastewater treatment plant). This is stirred in a closed flask at a constant temperature (20 °C or 25 °C) for 28 or 56 days, respectively. The consumption of oxygen is determined by measuring the change in pressure in the apparatus using an OxiTop® C (Xylem 35 Analytics Germany Sales GmbH & Co KG). Evolved carbon dioxide is absorbed in a solution of sodium hydroxide. Nitrification inhibitors are added to the flask to prevent usage of oxygen due to nitrification. The amount of oxygen taken up by the microbial population during biodegradation of the test substance (corrected for uptake by blank inoculum, run in parallel) is expressed as a percentage of ThOD (Theoretical oxygen demand, which is measured by the elemental analysis of the compound). A positive control Glucose/Glucosamine is run along with the test samples for each cabinet.

### Method for Evaluating Whiteness Benefit of Polymers in Laundry Detergent

Whiteness maintenance, also referred to as whiteness preservation, is the ability of a detergent to keep white items from whiteness loss when they are washed in the presence of soil. White garments can become dirty/dingy looking over time when soils are removed from dirty clothes and suspended in the wash water, then these soils can re-deposit onto clothing, making the clothing less white each time they are washed.

The whiteness benefit of polymers of the present disclosure is evaluated using automatic Tergotometer with 10 pots for laundry formulation testing.

SBL2004 test soil strips supplied by WFK Testgewebe GmbH are used to simulate consumer soil levels (mix of body soil, food, dirt etc.). Every 1 SBL2004 strip is loaded with 8 g soil. The SBL2004 test soil strips were cut into 5×5 cm squares for use in the test.

Black Todd Clay powder, from Warwick Equest Ltd., is an additional soil used to simulate particulate soil. Adding 0.25 g per wash cycle.

White Fabric swatches of Table 5 below purchased from WFK Testgewebe GmbH are used as whiteness tracers. Before the wash test, L, a, b and WI CIE values of all whiteness tracers are measured using Konica Minolta CM-3610D spectrophotometer.

TABLE 5

| | | % Fiber | Fabric | | |
|---|---|---|---|---|---|
| Code | Fiber Content | Content | Construction | Size | WFK Code |
| CK | Cotton | 100 | Weft Knit | (5 × 5 cm) | 19502_5 × 5_stamped |
| PC | Polyester/cotton | 65/35 | Weave | (5 × 5 cm) | 19503_5 × 5_stamped |
| PE | Polyester | 100 | Weft Knit | (5 × 5 cm) | 19508_5 × 5_stamped |
| PS | Polyester/Spandex ™ | 95/5 | Weft Knit | (5 × 5 cm) | 19507_5 × 5_stamped |

Additional ballast (background fabric swatches) is also used to simulate a fabric load and provide mechanical energy during the real laundry process. Ballast loads are comprised of cotton and polycotton knit swatches at 5×5 cm size.

4 cycles of wash are needed to complete the test:
Cycle 1: Desired amount of detergent and clay powder is fully dissolved by mixing with 1 L water (at defined hardness) in each tergotometer pot. 60 grams of fabrics, including whiteness tracers (4 types, each with 4 replicates), 10 pieces 5×5 cm SBL2004, and ballast are washed and rinsed in the tergotometer pot under defined conditions.

In the test of liquid laundry detergent composition wash concentration is 2500 ppm. The wash temperature is 30 °C, water hardness is 7 gpg.
Cycle 2: The whiteness tracers and ballast from each pot are then washed and rinsed again together with a new set of SBL2004 (5×5 cm, 10 pieces) and 0.25 g clay powder; then follow the process of cycle 1. All other conditions remain the same as cycle 1.
Cycle 3: The whiteness tracers and ballast from each pot are then washed and rinsed again together with a new set of SBL2004 (5×5 cm, 10 pieces) and 0.25 g clay powder; then follow the process of cycle 1. All other conditions remain the same as cycle 1.
Cycle 4: The whiteness tracers and ballast from each pot are then washed and rinsed again together with a new set of SBL2004 (5×5 cm, 10 pieces) and 0.25 g clay powder; then follow the process of cycle 1. All other conditions remain the same as cycle 1.

After Cycle 4, all whiteness tracers & ballast are laid out flat on the tray until dry, the tracers are then measured again using Konica Minolta CM-3610D spectrophotometer. The changes in Whiteness Index (ΔWI(CIE)) are calculated based on L, a, b measure before and after wash.

ΔWI(CIE)═WI(CIE)(after wash)−WI(CIE)(before wash).

### Method for Evaluating Stain Removal Benefit of Polymers in Laundry Detergent

Cleaning benefits of polymers are evaluated using automatic tergotometer. Some examples test stains suitable for this test are:
Dust Sebum on polycotton ex CFT
Highly Discriminating Sebum on polycotton ex CFT

The stains are analysed using Image Analysis System for Laundry stain removal testing before and after the wash.

SBL2004 test soil strips supplied by WFK Testgewebe GmbH are used to simulate consumer soil levels (mix of body soil, food, dirt etc.). Every 1 SBL2004 strip is loaded with 8 g soil. The SBL2004 test soil strips were cut into 5×5 cm squares for use in the test.

Additional ballast (background fabric swatches) is also used to simulate a fabric load and provide mechanical energy during the real laundry process. Ballast loads are comprised of knitted cotton swatches at 5×5 cm size. 4 cycles of the wash are performed:

The desired amount of detergent is fully dissolved by mixing with 1 L water (at defined hardness) in each tergotometer pot. 60 total grams of fabrics including stains (2 internal replicates of each stain in each pot), defined amount of 5×5 cm SBL2004 and ballast are washed and rinsed in the tergotometer pot under defined conditions.

All stains are tumbled dried between 60-65 °C. until dry, then stains are measured again using Image Analysis System for Laundry stain removal testing.

Stain Removal Index (SRI) are automatically calculated from the L, a, b values using the formula shown below. The higher the SRI, the better the stain removal.

$$SRI = {100}^{*} ( ( Δ {E}_{b} - Δ {E}_{a} ) / Δ {E}_{b} )$$

$$Δ {E}_{b} = \sqrt{( {( {L}_{c} - {L}_{b} )}^{2} + {( {a}_{c} - {a}_{b} )}^{2} + {( {b}_{c} - {b}_{b} )}^{2} )}$$

$$Δ {E}_{a} = \sqrt{( {( {L}_{c} - {L}_{a} )}^{2} + {( {a}_{c} - {a}_{a} )}^{2} + {( {b}_{c} - {b}_{a} )}^{2} )}$$

Subscript ‘b’ denotes data for the stain before washing
Subscript ‘a’ denotes data for the stain after washing
Subscript ‘c’ denotes data for the unstained fabric

### Synthesis of Compounds

Synthesis of Inventive Polymer Example IE 1: meso-Erythritol, Propoxylated with 8 Moles propylene oxide Per hydroxy Group

### Example 1a: Meso-Erythritol, Propoxylated with 3 Moles propylene oxide Per hydroxy Group

In a 2 l autoclave 122.1 g meso-erythritol and 1.6 g potassium tert. butoxide were placed and the mixture was heated to 130 °C. The vessel was purged three times with nitrogen and the mixture was heated to 140 °C 696.9 g propylene oxide was added within 13 hours. To complete the reaction, the mixture was allowed to post-react for additional 10 hours at 140 °C. The reaction mixture was stripped with nitrogen and volatile compounds were removed in vacuo at 80 °C. After filtration 815.0 g of a light brown oil was obtained.

### Example 1b: meso-Erythritol, Propoxylated with 8 Moles propylene oxide Per hydroxy Group

In a 2 l autoclave 245.7 g meso-erythritol, propoxylated with 3 moles propylene oxide per hydroxy group (example 1 a) and 0.7 g potassium tert. butoxide were placed and the mixture was heated to 80 °C. The vessel was purged three times with nitrogen and the mixture was heated to 140 °C. 348.5 g propylene oxide was added within 5 hours. To complete the reaction, the mixture was allowed to post-react for additional 7 hours at 140 °C. The reaction mixture was stripped with nitrogen and volatile compounds were removed in vacuo at 80 °C. After filtration 592.0 g of a light brown oil was obtained. Elemental composition was 60.6% carbon, 29.2% oxygen, 10.4% hydrogen.

### Synthesis of Inventive Polymer Example IE 10: Polyglycerol, Propoxylated with 4 Moles propylene oxide Per hydroxy Group

### Example 1a: Polyglycerol, Propoxylated with 4 Moles Propylene Oxide Per hydroxy Group

In a 2 l autoclave 150.0 g polyglycerol (polyglycerol HT, obtained from Solvay chemicals international, hydroxy value: 1148 mg KOH/g, this resembles 48.9 g per mole hydroxy group), and 1.7 g potassium tert. butoxide were placed and the mixture was heated to 130 °C. The vessel was purged three times with nitrogen and the mixture was heated to 140 °C. 713.1 g propylene oxide was added within 13 hours. To complete the reaction, the mixture was allowed to post-react for additional 10 hours at 140 °C. The reaction mixture was stripped with nitrogen and volatile compounds were removed in vacuo at 80 °C. After filtration 860.0 g of a light yellow oil was obtained. Elemental analysis: carbon=59.0%, oxygen=31.5%, hydrogen=10.2%

Other inventive polymer examples (IE1 to IE16) and comparative polymer examples (CE1 to CE7) were synthesized follow similar procedure by adjusting the type of polyol core and the amount of propylene oxide. The chemistry of IE1 to IE16, CE1 to CE7 are summarized in Table 6.

TABLE 6
inventive and comparative polymer samples.

| Example | Chemistry |
|---|---|
| IE1 | (meso-Erythritol)₁/(PO/OH)₈ |
| IE2 | (meso-Erythritol)₁/(PO/OH)₁₀ |
| IE3 | (meso-Erythritol)₁/(PO/OH)₁₅ |
| IE4 | (meso-Erythritol)₁/(PO/OH)_{17.5} |
| IE5 | (meso-Erythritol)₁/(PO/OH)₂₀ |
| IE6 | (meso-Erythritol)₁/(PO/OH)₂₅ |
| IE7 | (Diglycerol)₁/(PO/OH)₈ |
| IE8 | (Diglycerol)₁/(PO/OH)₁₅ |
| IE9 | (Pentaerythrit)₁/(PO/OH)₉ |
| IE10 | (Polyglycerol HT)₁/(PO/OH)₄ |
| IE11 | (Polyglycerol HT)₁/(PO/OH)₈ |
| IE12 | (Polyglycerol HT)₁/(PO/OH)₁₀ |
| IE13 | (Polyglycerol HT)₁/(PO/OH)₁₂ |
| IE14 | (Xylitol)₁/(PO/OH)₈ |
| IE15 | (Triglycerol)₁/(PO/OH)₈ |
| IE16 | (Triglycerol)₁/(PO/OH)₁₅ |
| CE1 | (Sorbitol)₁/(PO/OH)₁₀ |
| CE2 | (Sorbitol)₁/(PO/OH)₈ |
| CE3 | (Glycerol)₁/(PO/OH)₁₀ |
| CE4 | (Glycerol)₁/(PO/OH)₁₅ |
| CE5 | (Glycerol)₁/(PO/OH)₄ |
| CE6 | (Diglycerol)₁/(PO/OH)₃ |
| CE7 | (Triglycerol)₁/(PO/OH)₃ |

The polymer biodegradability test results according to method described above, the calculated F for Formula (1) and Formula (11) for inventive polymers IE1IE16, comparative polymer CE1-CE2 are summarized in Table 7. Inventive polymers IE1IE16 show improved biodegradability.

TABLE 7
Biodegradability test results, and calculated F for Formula (I) and Formula (II).

| | # —OH | # PO | | | | |
|---|---|---|---|---|---|---|
| | per Core | per —OH | Ether linkages | | F for Formula | F for Formula |
| Example | (Q) | (X) | in Core (P) | Biodeg (%) | (I) ^{a} | (II) ^{b} |
| IE1 | 4 | 8 | 0 | 75 | 2.216 | 0.106 |
| IE2 | 4 | 10 | 0 | 75 | 1.996 | 0.092 |
| IE3 | 4 | 15 | 0 | 80 | 1.446 | 0.056 |
| IE4 | 4 | 17.50 | 0 | 81 | 1.171 | 0.038 |
| IE5 | 4 | 20 | 0 | 79 | 0.896 | 0.020 |
| IE6 | 4 | 25 | 0 | 55 | 0.346 | −0.016 |
| IE7 | 4 | 8 | 1 | 82 | 0.832 | 0.051 |
| IE8 | 4 | 15 | 1 | 87 | 0.062 | 0.000 |
| IE9 | 4 | 9 | 0 | 82 | 2.106 | 0.099 |
| IE10 | 4.5 | 4 | 1.5 | 65 | 2.501 | 0.037 |
| IE11 | 4.5 | 8 | 1.5 | 70 | 1.643 | 0.013 |
| IE12 | 4.5 | 10 | 1.5 | 72 | 1.214 | 0.002 |
| IE13 | 4.5 | 12 | 1.5 | 50 | 0.785 | −0.010 |
| IE14 | 5 | 8 | 0 | 53 | 1.068 | −0.081 |
| IE15 | 5 | 8 | 2 | 79 | 3.838 | 0.032 |
| IE16 | 5 | 15 | 2 | 60 | 1.605 | 0.001 |
| CE1 | 6 | 10 | 0 | 8 | −1.136 | −0.272 |
| CE2 | 6 | 8 | 0 | 5 | −0.080 | −0.268 |

^{a} corresponding to biodegradability >40% in OECD 301F test
^{b} corresponding to biodegradability >60% in OECD 301F test.

### Polymer Stain Removal Performance in Liquid Detergent:

Liquid detergent composition E, F below are prepared by traditional means known to those of ordinary skill in the art by mixing the listed ingredients (Table 8).

The stain removal performance of the inventive polymers is evaluated according to the method for evaluating stain removal benefit of polymers in laundry detergent above. The Liquid detergent concentration is 2500 ppm, fabrics are washed at 30 °C for 12 minutes at 7 gpg hardness, followed by 5 minute rinse at 15 °C. 11 SBL squares were added as soil to simulate consumer soil levels.

By directly comparing the stain removal of reference composition E and test composition F. ΔSRI of composition F vs composition E is reported in Table 9 as an indication of polymer stain removal performance.

TABLE 8

| | | F (Test composition: |
|---|---|---|
| | E | reference + Inventive |
| | (reference | or comparative |
| Ingredients (wt %) | composition) | polymer) |
| LAS | 9.7 | 9.7 |
| AES | 7.0 | 7.0 |
| C₁₂₋₁₄ EO₉ nonionic surfactant | 6.1 | 6.1 |
| Propylene glycol | 6.0 | 6.0 |
| Sodium Lauryl Sulfate | 5.2 | 5.2 |
| Ethanolamine | 3.9 | 3.9 |
| Monoethanolamine | 3.9 | 3.9 |
| Inventive Polymer Examples | 0 | 3.89 |
| Citric acid | 2.4 | 2.4 |
| Boron sodium oxide | 2.2 | 2.2 |
| Fatty acids | 2.0 | 2.0 |
| Ethanol | 1.9 | 1.9 |
| Perfume | 0.75 | 0.75 |
| Chelant | 0.34 | 0.34 |
| Suds Suppressor | 0.2 | 0.2 |
| Enzyme (including Protease, | 0.11 | 0.11 |
| Amylase, Mannanase, Pectawash) | | |
| Sodium cumene sulfonate | 0.1 | 0.1 |
| Hydrogenated Castor Oil | 0.082 | 0.082 |
| Water/minors | Balance | Balance |

Chelant = DETA + GLDA
Perfume = Free perfume + PMC (Perfume Micro Capsule)

As shown in Table 9, inventive polymers deliver significant stain removal benefit on sebum stains. No significant stain removal benefit on sebum can be observed for comparative samples which comprises only 3 polypropylene oxide units (POs).

TABLE 9

| | | ΔSRI vs Reference (Dust |
|---|---|---|
| Polymer | Chemistry | Sebum on polycotton) |
| IE3 | (meso-Erythritol)₁/(PO/OH)₁₅ | 10.4s |
| IE7 | (Diglycerol)₁/(PO/OH)₈ | 4.6s |
| IE8 | (Diglycerol)₁/(PO/OH)₁₅ | 7.1s |
| IE9 | (Pentaerythrit)₁/(PO/OH)₉ | 10.5s |
| IE15 | (Triglycerol)₁/(PO/OH)₈ | 7.0s |
| IE16 | (Triglycerol)₁/(PO/OH)₁₅ | 8.2s |
| CE6 | (Diglycerol)₁/(PO/OH)₃ | 1.5 |
| CE7 | (Triglycerol)₁/(PO/OH)₃ | 2.4 |

s: data are statistically significant vs E (reference composition).

Liquid detergent composition G, H are prepared by traditional means known to those of ordinary skill in the art by mixing the listed ingredients (Table 10), and evaluated according to the method for evaluating stain removal benefit of polymers in laundry detergent.

The Liquid detergent concentration is 26.1 ppm, fabrics are washed at 30 °C for 12 minutes at 7 gpg hardness, followed by 5 minute rinse at 15 °C. 11 SBL squares were added as soil to simulate consumer soil levels.

ΔSRI of composition H vs composition G is reported in Table 10, composition H with inventive polymer IE10 based on polyglycerol core show statistically better discriminating sebum removal performance than composition G with comparative polymer CE5 based on glycerol core.

TABLE 10

| | G (composition | H (composition |
|---|---|---|
| | with comparative | with inventive |
| Ingredients (wt %) | polymer) | polymer) |
| LAS | 9.7 | 9.7 |
| AES | 7.0 | 7.0 |
| C₁₂₋₁₄ EO9 nonionic surfactant | 6.1 | 6.1 |
| Propylene glycol | 6.0 | 6.0 |
| Sodium Lauryl Sulfate | 5.2 | 5.2 |
| Ethanolamine | 3.9 | 3.9 |
| Monoethanolamine | 3.9 | 3.9 |
| Comparative Polymer CE5, | 3.89 | 0 |
| (Glycerol)₁/(PO/OH)₄ | | |
| Inventive Polymer IE10, | 0 | 3.89 |
| (Polyglycerol HT)₁/(PO/OH)₄ | | |
| Citric acid | 2.4 | 2.4 |
| Boron sodium oxide | 2.2 | 2.2 |
| Fatty acids | 2.0 | 2.0 |
| Ethanol | 1.9 | 1.9 |
| Perfume | 0.75 | 0.75 |
| Chelant | 0.34 | 0.34 |
| Suds Suppressor | 0.2 | 0.2 |
| Enzyme (including Protease, | 0.11 | 0.11 |
| Amylase, Mannanase, Pectawash) | | |
| Sodium cumene sulfonate | 0.1 | 0.1 |
| Hydrogenated Castor Oil | 0.082 | 0.082 |
| Water/minors | Balance | Balance |
| ΔSRI (Highly Discriminating | Reference | +3.3s |
| Sebum on polycotton) | | |

Chelant = DETA + GLDA
Perfume = Free perfume + PMC (Perfume Micro Capsule)
s: data are statistically significant vs G (composition with comparative polymer).

Liquid detergent composition I, K below are prepared by traditional means known to those of ordinary skill in the art by mixing the listed ingredients (Table 11), and evaluated according to the method for evaluating stain removal benefit of polymers in laundry detergent.

The Liquid detergent concentration is 26.1 ppm, fabrics are washed at 30 °C for 12 minutes at 7 gpg hardness, followed by 5 minute rinse at 15 °C. 11 SBL squares were added as soil to simulate consumer soil levels.

ΔSRI of composition K vs composition I is reported in Table 11, composition K with inventive polymer IE3 based on meso-erythritol core show statistically better discriminating sebum removal performance than composition G with comparative polymer CE4 based on glycerol core.

TABLE 11

| | I (composition | K (composition |
|---|---|---|
| | with comparative | with inventive |
| Ingredients (wt %) | polymer) | polymer) |
| LAS | 9.7 | 9.7 |
| AES | 7.0 | 7.0 |
| C₁₂₋₁₄ EO₉ nonionic surfactant | 6.1 | 6.1 |
| Propylene glycol | 6.0 | 6.0 |
| Sodium Lauryl Sulfate | 5.2 | 5.2 |
| Ethanolamine | 3.9 | 3.9 |
| Monoethanolamine | 3.9 | 3.9 |
| Comparative Polymer CE4, | 3.89 | 0 |
| (Glycerol)₁/(PO/OH)₁₅ | | |
| Inventive Polymer IE3 | 0 | 3.89 |
| (meso-Erythritol)₁/(PO/OH)₁₅ | | |
| Citric acid | 2.4 | 2.4 |
| Boron sodium oxide | 2.2 | 2.2 |
| Fatty acids | 2.0 | 2.0 |
| Ethanol | 1.9 | 1.9 |
| Perfume | 0.75 | 0.75 |
| Chelant | 0.34 | 0.34 |
| Suds Suppressor | 0.2 | 0.2 |
| Enzyme (including Protease, | 0.11 | 0.11 |
| Amylase, Mannanase, Pectawash) | | |
| Sodium cumene sulfonate | 0.1 | 0.1 |
| Hydrogenated Castor Oil | 0.082 | 0.082 |
| Water/minors | Balance | Balance |
| ΔSRI (Highly Discriminating | Reference | +3.4s |
| Sebum on polycotton) | | |

Chelant = DETA + GLDA
Perfume = Free perfume + PMC (Perfume Micro Capsule)
s: data are statistically significant vs I (composition with comparative polymer).

Liquid detergent composition L, M below are prepared by traditional means known to those of ordinary skill in the art by mixing the listed ingredients (Table 12), and evaluated according to the method for evaluating stain removal benefit of polymers in laundry detergent.

The Liquid detergent concentration is 2740 ppm, fabrics are washed at 30 °C for 40 minutes at 7 gpg hardness, followed by 2×5 minute rinse at 15 °C 20 SBL squares were added as soil to simulate consumer soil levels.

ΔSRI of composition M vs composition L is reported in Table 12, composition M with inventive polymer IE3 based on meso-erythritol core show statistically better dust sebum removal performance than composition L with no polymer.

TABLE 12

| | L (composition | M (composition |
|---|---|---|
| | with no | with inventive |
| Ingredients (wt %) | polymer) | polymer) |
| LAS | 13.82 | 13.82 |
| AES C₂₄E₃S | 7.18 | 7.18 |
| NI 24-7 | 5.83 | 5.83 |
| Sodium Cumene Sulphonate | 3.12 | 3.12 |
| NaOH | 2.69 | 2.69 |
| Fatty Acid | 2.63 | 2.63 |
| Perfume | 2.00 | 2.00 |
| Chelant (DTPMP) | 1.17 | 1.17 |
| Citric Acid | 0.82 | 0.82 |
| Ethanol | 0.64 | 0.64 |
| Hydrogenated Castor Oil | 0.23 | 0.23 |
| Brightener | 0.11 | 0.11 |
| Protease | 0.037 | 0.037 |
| Hueing Dye | 0.016 | 0.016 |
| CaCl2 | 0.011 | 0.011 |
| 1,2-Benzisothiazolin-3-one (BIT) | 0.009 | 0.009 |
| Phosphodiesterase | 0.007 | 0.007 |
| Amylase | 0.006 | 0.006 |
| Blue Dye | 0.005 | 0.005 |
| Silicone Suds Supressor | 0.003 | 0.003 |
| Mannase | 0.002 | 0.002 |
| Pectawash | 0.002 | 0.002 |
| Inventive Polymer IE3 | 0.000 | 1.824 |
| (meso-Erythritol)₁/(PO/OH)₁₅ | | |
| Water/Minors | Balance | Balance |
| ΔSRI (Dust Sebum on polycotton) | Reference | +10.8s |

### Polymer Anti-Redeposition Performance in Laundry Detergents

The following liquid laundry detergent composition (Table 13) was used as base detergent to test polymer anti-redeposition performance. Polymer anti-redeposition performance were tested using the following conditions:

3000 ppm clay, 688 ppm base detergent/25 °C/1 mM hardness/19.6 ppm polymer.

TABLE 13
Liquid laundry base detergent for polymer
anti-redeposition and cleaning test.

| | Comp (% wt) |
|---|---|
| Linear alkylbenzene sulfonate LAS | 8.9 |
| C₁₀-C₁₆ Alkyl Sulfate SLS | 7.7 |
| nonionic surfactant | 7.8 |
| Amine oxide | 0.6 |
| Inventive Polymer | 1 |
| Citric acid | 1.8 |
| Enzymes (combined) | 0.079 |
| Sodium tetraborate | 1.5 |
| Calcium/sodium formate | 0.13 |
| DTPA | 0.5 |
| Brightener ^{a} | 0.08 |
| Ethanol | 1.7 |
| Propylene glycol | 2.3 |
| Monoethanolamine | 2.65 |
| DETA | 0.05 |
| Sodium cumene sulfonate (NaCS) | 1.3 |
| Aesthetic dye | 0.01 |
| Perfume ^{b} | 0.6 |
| Antifoam ^{c} | 0.21 |
| Hueing dye | 0.026 |
| Water & minors | balance |

^{a} Fluorescent Brightener is disodium 4,4′-bis{[4-anilino-6-morpholino-s-triazin-2-yl]-amino}-2,2′-stilbenedisulfonate or 2,2′-([1,1′-Biphenyl]-4,4′-diyldi-2,1-ethenediyl)bis-benzenesulfonic acid disodium salt.
^{b} 3,5-bis(1,1-dimethylethyl)-4-hydroxybenzenepropanoic acid, methyl ester [6386-38-5]
^{c} Dow Corning supplied antifoam blend 80-92% ethylmethyl, methyl(2-phenyl propyl)siloxane; 5-14% MQ Resin in octyl stearate a 3-7% modified silica.

### Test Preparation:

The following fabrics are provided for the whiteness benefit test:

Knitted Cotton: Test fabrics, Inc 403 cotton interlock knit tubular CW120, available from Empirical Manufacturing Company (Cincinnati, OH, USA).

The fabrics were prepared according to the following method: 400 g fabrics are washed in a WE Miniwasher Electrolux EWC1350 (3.5 litre water) twice using the short program (45-minute wash cycle followed by three rinse cycles; total program is 90 minutes) at 60 °C with 18.6 g Ariel™ Compact powder detergent, twice using the short program, at 60 °C nil detergent, and then three times using the short program at 40 °C with 8.2 g Lenor™ Concentrate (a fabric enhancer) into each main wash. Fabrics are then dried in a tumble dryer on extra dry until dry.

### Test Method:

Each sample is run in a 96 well plate simulated washing system that uses magnetized bearings to simulate the agitation of a typical full scale washing machine according to the following conditions: 750 ppm detergent concentration, 150 μL water per well, 25 °C, water hardness of 1.0 mM (3:1 Ca⁺²: Mg⁺² molar ratio), wash pH of 8.3, 3000 ppm Arizona test dust (supplied by PTI, Powder Technology Inc).

Each fabric is washed for 60 minutes and dried in the dark under ambient conditions. For each wash condition, there are six 96 well plates, and eight internal replicates per 96 well plate, for a total of 48 replicates.

When the samples are dry, L*, a*, b* and CIE WI are measured on each 96 well plate spot using a Spectrolino imaging system (Gretag Macbeth, Spectro Scan 3.273). For each treatment, the average CIE WI is determined. Delta CIE WI, as reported in Table below, is the difference of the average CIE WI of the sample vs. the average CIE WI of a control sample without the tested polymer (nil polymer).

For the whiteness index, the CIE whiteness index formula was used and delta WI was calculated as follows: delta WI on a substrate=WI technology −WI nil.

The results are shown in Table 14, inventive polymers can deliver clear anti-redeposition performance.

TABLE 14
Polymer anti-redeposition performance on
knitted cotton (washed and FE treated)

| | | Add. | Delta CIE WI |
|---|---|---|---|
| Example | Chemistry | ppm | vs. nil polymer |
| Nil polymer | | | 0 (ref) |
| IE2 | (meso-Erythritol)₁/(PO/OH)₁₀ | 19.6 | +14.95 |
| IE12 | (Polyglycerol HT)₁/(PO/OH)₁₀ | 19.6 | +15.48 |

### Polymer Cleaning Performance in Laundry Detergent

Polymer cleaning performance in laundry detergent were carried out with the formulation stated Table 13 and the washing conditions for single wash cycle performance may be summarized as follows:
Machine: Launder-o-meter
Washing liquor 500 mL
Washing time 30 minutes
Washing temperature 25 °C
Detergent concentration 0.688 g/L
Water hardness 1 mmol/L; (Ca:Mg):HCO3 (4:1):8
Soiled fabrics: WFK 20D from CFT

After the one cycle, soiled fabrics were twice rinsed with water, followed by shortly spin-drying and drying at room temperature over a period of 12 hours.

To evaluate the primary detergency of the stains, soiled fabrics were determined before and after washing using soil removal index (SRI) formula from ASTM D4265. For obtaining the reflectance values for the respective fabric both before and after washing using a reflectometer (MACH5+, a multi area color measurement instrument from ColourConsult). Higher delta reflectance values demonstrate a better primary detergency.
ASTM D4265-14: Evaluation of Stain Removal Performance in Home Laundry
Stain Removal Index=SRI

SRI=100×(((delta E*(before wash−unstained)−delta E*(after wash −unstained))/delta E*(before wash−unstained)))

delta E*=((delat L*)²+(delta a*)²+(delta b*)²)%

Average delta SRI=(sum delta SRI all stains)/number of stains

The cleaning performance of inventive polymers is summarized in Table 15. Inventive polymers can deliver clear improvement on sebum stain removal (WFK 20D).

TABLE 15
Polymer sebum cleaning performance.

| | | Additive | Delta SRI |
|---|---|---|---|
| Example | Chemistry | ppm | (WFK20D) |
| Nil polymer | | 19.6 | 0 (ref) |
| IE2 | (meso-Erythritol)₁/(PO/OH)₁₀ | 19.6 | +8.07 |
| IE12 | (Polyglycerol HT)₁/(PO/OH)₁₀ | 19.6 | +8.83 |
| CE3 | (Glycerol)₁/(PO/OH)₁₀ | 19.6 | +4.63 |

### Polymer Whiteness Performance in Liquid Detergent:

Liquid detergent composition E, K below are prepared by traditional means known to those of ordinary skill in the art by mixing the listed ingredients (Table 16) and evaluated according to the method for evaluating whiteness maintenance benefit of polymers in laundry detergent. ΔWI CIE of composition K vs composition E is reported in Table 16, composition K with inventive polymer IE3 based on meso-erythritol core show meaningfully better whiteness maintenance performance than composition E.

TABLE 16

| | | K (Test |
|---|---|---|
| | | composition: |
| | | reference + |
| | E | Inventive or |
| | (reference | comparative |
| Ingredients (wt %) | composition) | polymer) |
| LAS | 9.7 | 9.7 |
| AES | 7.0 | 7.0 |
| C₁₂₋₁₄ EO₉ nonionic surfactant | 6.1 | 6.1 |
| Propylene glycol | 6.0 | 6.0 |
| Sodium Lauryl Sulfate | 5.2 | 5.2 |
| Ethanolamine | 3.9 | 3.9 |
| Monoethanolamine | 3.9 | 3.9 |
| Inventive Polymer IE3 | 0 | 3.89 |
| (meso-Erythritol)₁/(PO/OH)₁₅ | | |
| Citric acid | 2.4 | 2.4 |
| Boron sodium oxide | 2.2 | 2.2 |
| Fatty acids | 2.0 | 2.0 |
| Ethanol | 1.9 | 1.9 |
| Perfume | 0.75 | 0.75 |
| Chelant | 0.34 | 0.34 |
| Suds Suppressor | 0.2 | 0.2 |
| Enzyme (including Protease, | 0.11 | 0.11 |
| Amylase, Mannanase, Pectawash) | | |
| Sodium cumene sulfonate | 0.1 | 0.1 |
| Hydrogenated Castor Oil | 0.082 | 0.082 |
| Water/minors | Balance | Balance |
| ΔWI CIE (polycotton) | Reference | +6.1* |

Chelant = DETA + GLDA
Perfume = Free perfume + PMC (Perfume Micro Capsule)
*difference in consumer noticeable range (>4 WI CIE units)

1.-16. (canceled)

17. A propoxylated polyol comprising a polyol core consisting essentially of four to five —OH groups, wherein at least one of the —OH groups is modified to form a polypropylene oxide branch, wherein the propoxylated polyol comprises polypropylene oxide branches comprising on average at least four polypropylene oxide units.

18. The propoxylated polyol according to claim 17, wherein the polyol core is a monomer, oligomer or polymer, wherein each of the oligomer and the polymer comprises a plurality of subunits.

19. The propoxylated polyol according to claim 17, wherein the propoxylated polyol comprises polypropylene oxide branches comprising on average at least at least 5 polypropylene oxide units (POs),

20. The propoxylated polyol according to claim 19, wherein the propoxylated polyol comprises polypropylene oxide branches comprises at least 6 POs.

21. The propoxylated polyol according to claim 17, wherein the propoxylated polyol comprises polypropylene oxide branches comprising on average not more than 30 Pos.

22. The propoxylated polyol according to claim 21, wherein the propoxylated polyol comprises polypropylene oxide branches comprises not more than 25 POs.

23. The propoxylated polyol according to claim 17, wherein the polyol core has a weight ranging from 90 to 500 g/mol.

24. The propoxylated polyol according to claim 17, wherein the propoxylated polyol has a structure such that F is 0 or greater than 0 for Formula (I) or Formula (II), wherein:
Formula (I) is:
F=2.769PQ−12.46P−0.209QX+0.524Q+0.726X+1; and
Formula (II) is:
F=0.1123PQ−0.505P+0.0027QX−0.209Q−0.018X+1;
wherein
X=the average number of POs per propylene oxide branch;
P=the average number of ether linkages in the polyol core; and
Q=the average number of —OH groups in the polyol core.

25. The propoxylated polyol according to claim 17, wherein the weight average molecular weight (Mw) of the propoxylated polyol is in the range of from 700 to 6,000 g/mol.

26. The propoxylated polyol according to claim 17, wherein the polyol core is selected from the group consisting of meso-Erythritol, D-threitol, L-threitol, 1,2,5,6-hexanetetrol, pentaerythritol, xylitol, ribitol, arabitol, pentitol, diglycerol, triglycerol, and polyglycerol.

27. The propoxylated polyol according to claim 17, wherein the amount of secondary alcohol groups in the propoxylated polyol is in the range of from 30 to 100%.

28. The propoxylated polyol according to claim 27, wherein the amount of secondary alcohol groups in the propoxylated polyol based on the indicated polyols is in the ranges as follows:
meso-Erythritol: 50 to 100%; D-threitol: 50 to 100%; L-threitol: 50 to 100%; 1,2,5,6-hexanetetrol: 50 to 100%; pentaerythritol: 30 to 100%; xylitol: 60 to 100%; ribitol: 60 to 100%; arabitol: 60 to 100%; pentitol: 60 to 100%; and polyglycerol: 33 to 100%.

29. A process for preparing the propoxylated polyol according to claim 17, wherein a polyol essentially consisting of four to five —OH groups is reacted with at least 16 propylene oxide molecules in order to obtain the respective propoxylated polyol.

30. The process according to claim 29, wherein the polyol essentially consisting of four to five —OH groups is selected from the group consisting of meso-Erythritol, D-threitol, L-threitol, 1,2,5,6-hexanetetrol, pentaerythritol, xylitol, ribitol, arabitol, pentitol, and polyglycerol.

31. A method of preparing laundry detergents, cleaning compositions, fabric and home care products, cosmetic formulations, crude oil emulsion breakers, pigment dispersions for ink jet inks, formulations for electro plating, cementitious compositions or dispersants for agrochemical formulations, the method comprising using the propoxylated polyol according to claim 17.

32. The method according to claim 31, wherein the cleaning compositions are for
i) sebum removal, or
ii) improved removal of oily/fatty stains, or
iii) soil removal of particulate stains, or
iv) dispersion or emulsification of soils, or
v) modification of treated surface to improve removal upon later re-soiling, or
vi) whiteness improvement.

33. The method according to claim 32, wherein the cleaning composition are for
i) clay removal or ii) removal of oily/fatty stains, and wherein the cleaning composition is a laundry detergent formulation, a manual dish wash detergent formulation, a formulation suitable for (pre)-treatment of textiles, or soap bars.

33. A laundry detergent, cleaning composition, fabric and home care product, cosmetic formulation, crude oil emulsion breaker, pigment dispersion for ink jet inks, formulation for electro plating, cementitious composition or dispersant for agrochemical formulations, comprising at least one propoxylated polyol according to claim 17.

34. The laundry detergent, cleaning composition, fabric or home care product according to claim 33, further comprising:
(a) an antimicrobial agent selected from the group consisting of 2-phenoxyethanol and 4,4′-dichloro 2-hydroxydiphenylether or
(b) at least one enzyme selected from the list consisting of lipases, hydrolases, amylases, DNases, proteases, cellulases, hemicellulases, phospholipases, esterases, mannanases, xylanases, dispersins, oxidoreductases, cutinases, pectate lyases, pectinases, lactases and peroxidases, and combinations of at least two of the foregoing types.
